(19) United States
(12) Patent Application Publication
(10) Pub. No.: US 2021/0122938 A1
(43) Pub. Date: Apr. 29, 2021

(54) PIGMENT DISPERSION COMPOSITION, CURABLE COMPOSITION, STORED CONTAINER, TWO-DIMENSIONAL OR THREE-DIMENSIONAL IMAGE FORMING APPARATUS, TWO-DIMENSIONAL OR THREE-DIMENSIONAL IMAGE FORMING METHOD, CURED PRODUCT, AND DECORATED PRODUCT

(71) Applicants: Masahide Kobayashi, Kanagawa (JP); Mitsunobu Morita, Shizuoka (JP); Takashi Okada, Kanagawa (JP); Takenori Suenaga, Kanagawa (JP); Soh Noguchi, Kanagawa (JP); Tatsuki Yamaguchi, Kanagawa (JP)

(72) Inventors: Masahide Kobayashi, Kanagawa (JP); Mitsunobu Morita, Shizuoka (JP); Takashi Okada, Kanagawa (JP); Takenori Suenaga, Kanagawa (JP); Soh Noguchi, Kanagawa (JP); Tatsuki Yamaguchi, Kanagawa (JP)

(21) Appl. No.: 17/066,641

(22) Filed: Oct. 9, 2020

(30) Foreign Application Priority Data
Oct. 23, 2019 (JP) 2019-192641

(51) Int. Cl. C09D 17/00; C09D 11/101; C09D 11/107; C08F 226/06; C08F 220/20; C08F 220/28; C08F 224/00; C08L 101/00; B41J 2/175; B41M 5/00

(52) U.S. Cl. CPC C09D 17/003; C09D 11/101; C09D 11/107; C08F 226/06; C08F 220/20; B33Y 70/00; C08F 220/282; C08F 224/00; C08L 101/00; B41J 2/17503; B41M 5/0023; C08F 220/286

(57) ABSTRACT

Provided is a pigment dispersion composition including: a yellow pigment; a polymerizable compound having a solubility parameter (SP value) of 10.00 or greater; and a pigment dispersant having an amine value of 30 mgKOH/g or greater but 100 mgKOH/g or less, wherein a ratio (B/A) of a content (B) of the pigment dispersant to a content (A) of the yellow pigment is 0.10 or greater but 0.80 or less.

### CROSS-REFERENCE TO RELATED APPLICATIONS

This patent application is based on and claims priority pursuant to 35 U.S.C. § 119(a) to Japanese Patent Application No. 2019-192641, filed on Oct. 23, 2019, in the Japan Patent Office, the entire disclosure of which is hereby incorporated by reference herein.

### BACKGROUND

### Technical Field

The present disclosure relates to a pigment dispersion composition, a curable composition, a stored container, a two-dimensional or three-dimensional image forming apparatus, a two-dimensional or three-dimensional image forming method, a cured product, and a decorated product.

### Description of the Related Art

Curable compositions, which are solvent-free and do not generate volatile organic compounds (hereinafter, may be referred to as “VOC”), are advantageous in environmental friendliness, quick drying property, and recording ability over liquid-non-absorbable recording media.

From various durability-related viewpoints, pigment-based inks are often demanded as curable inks, which are curable compositions containing pigment dispersion compositions. Pigments need to be uniformly dispersed in the compositions. It is known that degradation of pigment dispersibility brings about degradation of liquid permeability during filtration and degradation of discharging stability such as nozzle clogging.

Examples of the method for uniformly dispersing pigments in pigment dispersion compositions include coating of pigments with resins and addition of dispersants. For example, a proposed inkjet ink contains a polymeric dispersant free and not adsorbed to the pigment, in an amount of 1.0% by mass or less of the whole ink.

A proposed method for producing an active-energy-ray-curable pigment dispersion disperses a composition containing a pigment, a pigment dispersant, phenoxyethyl acrylate serving as a polymerizable compound, and a polymerization inhibitor in a manner that the difference between the highest temperature and the lowest temperature will be g degrees C. or more.

### SUMMARY

According to an aspect of the present disclosure, a pigment dispersion composition includes a yellow pigment, a polymerizable compound having a solubility parameter (SP value) of 10.00 or greater, and a pigment dispersant having an amine value of 30 mgKOH/g or greater but 100 mgKOH/g or less. The ratio (B/A) of the content (B) of the pigment dispersant to the content (A) of the yellow pigment is 0.10 or greater but 0.80 or less.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic view illustrating an example of an image forming apparatus including an inkjet discharging unit according to an embodiment of the present disclosure;

FIG. 2 is a schematic view illustrating another example of an image forming apparatus (three-dimensional image forming apparatus) according to an embodiment of the present disclosure; and

FIGS. 3A to 3D are schematic views illustrating an example of a method for producing a three-dimensional object using a composition according to an embodiment of the present disclosure.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

According to the present disclosure, it is possible to provide a pigment dispersion composition that is excellent in storage stability when a yellow pigment is used as a colorant.

### (Pigment Dispersion Composition)

A pigment dispersion composition of the present disclosure includes a yellow pigment, a polymerizable compound having a solubility parameter (SP value) of 10.00 or greater, and a pigment dispersant having an amine value of 30 mgKOH/g or greater but 100 mgKOH/g or less. The ratio (B/A) of the content (B) of the pigment dispersant to the content (A) of the yellow pigment is 0.10 or greater but 0.80 or less. The pigment dispersion composition further contains other components as needed.

Existing pigment dispersion compositions use a polymerizable compound (e.g., phenoxyethyl acrylate) having a SP value of less than 10.00 and having a great polarity difference from the pigment dispersant. This makes the affinity between the pigment and the polymerizable compound unstable, and brings about a problem that the wettability of the pigment degrades and storage stability degrades. Inkjet inks (curable compositions) containing pigment dispersion compositions having a low storage stability have a problem that storage stability, liquid permeability, discharging stability, and curability are poor, and ink film adhesiveness is low.

As a result of earnest studies, the inventors of the present invention have found that a pigment dispersion composition that includes a yellow pigment, a polymerizable compound having a SP value of 10.00 or greater, and a pigment dispersant having an amine value of 30 mgKOH/g or greater but 100 mgKOH/g or less, and has a ratio (B/A) of 0.10 or greater but 0.80 or less between the content (B) of the pigment dispersant and the content (A) of the yellow pigment enables a good affinity balance between the yellow pigment and the dispersion medium (polymerizable compound) and enables improvement of wettability of the pigment by the dispersion medium, through adsorption of the pigment dispersant to the surface of the yellow pigment. When the SP value of the polymerizable compound in the pigment dispersion composition is 10.00 or greater, the polarity difference (SP value difference) between the polymerizable compound and the pigment dispersant is low. This makes adsorption of the pigment dispersant to the yellow pigment stable, making it possible to realize a high storage stability through a steric repulsion effect.

### <Pigment Dispersant>

The pigment dispersant has an amine value of 30 mgKOH/g or greater but 100 mgKOH/g or less, and preferably 50 mgKOH/g or greater but 85 mgKOH/g or less. When the amine value is 30 mgKOH/g or greater but 100 mgKOH/g or less, adsorption of the pigment dispersant to the yellow pigment is stabilized, making it possible to obtain a high storage stability through a steric repulsion effect. This also makes it possible to suppress polymerization reaction between the pigment dispersant and the polymerizable compound during a long term of storage or during heating, making it possible to realize a low viscosity change ratio and a high storage stability.

To obtain the amine value, the pigment dispersant (i g) is dissolved in methyl isobutyl ketone (100 mL), and potentiometrically titrated with an automatic titrator (instrument name: GT-200, available from Mitsubishi Chemical Analytech Co., Ltd.) using a 0.01 mol/L methyl isobutyl ketone chlorate solution, to measure a potential difference. The amine value can be calculated based on the obtained potential difference.

The pigment dispersant is preferably, for example, a dispersant polymer because a dispersant polymer serving as the pigment dispersant can be stably adsorbed to the yellow pigment and realize a higher storage stability through a steric repulsion effect.

Examples of the dispersant polymer include, but are not limited to, basic functional group-containing copolymers, acrylic block copolymers, and copolymers containing an alkylol ammonium salt and an acid group. One of these dispersant polymers may be used alone or two or more of these dispersant polymers may be used in combination.

Examples of the basic functional group-containing copolymers include, but are not limited to, copolymers each containing a basic polar functional group such as an amino group, an imino group, an amide group, an imide group, and a nitrogen-containing heterocyclic group. The basic polar functional group facilitates adsorption of the basic functional group-containing copolymer to the surface of the yellow pigment, making it possible to obtain a high storage stability. A preferable basic functional group-containing copolymer is a copolymer containing an amino group in terms of adsorptivity to the yellow pigment, dispersibility in the polymerizable compound, and an anti-thickening property of the pigment dispersion composition.

Examples of the acrylic block copolymers include, but are not limited to, block copolymers containing a hydrophobic block and a hydrophilic block. A dispersant polymer formed of an acrylic block copolymer can realize a high storage stability through a steric repulsion effect, with the hydrophilic block oriented over the surface of the yellow pigment and the hydrophobic block spread to the dispersion medium. Meanwhile, an acrylic block copolymer coating the surface of the yellow pigment can reduce the surface activity of the yellow pigment, improve dispersibility of the yellow pigment in the dispersion medium, and realize a high dispersibility.

Examples of the copolymers containing an alkylol ammonium salt and an acid group include, but are not limited to, copolymers of a (meth)acryloyl alkylol ammonium salt and (meth)acrylic acid. Preferable examples of the copolymers of a (meth)acryloyl alkylol ammonium salt and (meth) acrylic acid include, but are not limited to, random copolymers and block copolymers.

An appropriately synthesized product or a commercially available product may be used as the dispersant polymer.

Examples of the commercially available product of the basic functional group-containing copolymers include, but are not limited to, SOLSPERSE series available from Nippon Lubrizol Corporation such as SOLSPERSE 20000 (with an amine value of 35.9 mgKOH/g), SOLSPERSE 24000 (with an amine value of 41.6 mgKOH/g), SOLSPERSE 32000 (with an amine value of 31.2 mgKOH/g), SOLSPERSE 33000 (with an amine value of 43.0 mgKOH/g), SOLSPERSE 35000 (with an amine value of 32.0 mgKOH/g), SOLSPERSE 56000 (with an amine value of 39.0 mgKOH/g), SOLSPERSE 71000 (with an amine value of 75.0 mgKOH/g), SOLSPERSE 73000 (with an amine value of 80.0 mgKOH/g), SOLSPERSE 74000 (with an amine value of 81.0 mgKOH/g), and SOLSPERSE 88000 (with an amine value of 33.0 mgKOH/g). One of these commercially available products may be used alone or two or more of these commercially available products may be used in combination.

Examples of the commercially available product of the acrylic block copolymers include, but are not limited to, DISPERBYK series available from Byk-Chemie Japan KK. such as DISPERBYK-2050 (with an amine value of 30.7 mgKOH/g), DISPERBYK-2055 (with an amine value of 45.1 mgKOH/g), DISPERBYK-2150 (with an amine value of 56.7 mgKOH/g), and DISPERBYK-2155 (with an amine value of 52.5 mgKOH/g). One of these commercially available products may be used alone or two or more of these commercially available products may be used in combination.

Examples of the commercially available product of the copolymers containing an alkylol ammonium salt and an acid group include, but are not limited to, DISPERBYK-140 (with an amine value of 76.0 mgKOH/g) and DISPERBYK-180 (with an amine value of 94.0 mgKOH/g). One of these commercially available products may be used alone or two or more of these commercially available products may be used in combination.

The weight average molecular weight of the dispersant polymer is preferably 1,000 or greater and more preferably 1,000 or greater but 10,000 or less. The weight average molecule weight can be measured by, for example, gel permeation chromatography (GPC).

The content of the pigment dispersant is preferably 2% by mass or greater but 12% by mass or less and more preferably 2% by mass or greater but 7.5% by mass or less relative to the total amount of the pigment dispersion composition.

The ratio (B/A) of the content (B) of the pigment dispersant to the content (A) of the yellow pigment is 0.10 or greater but 0.80 or less and preferably 0.10 or greater but 0.50 or less. When the content ratio (B/A) is 0.10 or greater, a high storage stability can be realized through a steric repulsion effect of the pigment dispersant adsorbed to the yellow pigment. When the content ratio (B/A) is 0.80 or less, the amount of the pigment dispersant not adsorbed to the yellow pigment is low, making it possible to better suppress the viscosity of the pigment dispersion composition and realize a high storage stability.

The content of the pigment dispersant not adsorbed to the yellow pigment is preferably 15% by mass or greater but 50% by mass or less relative to the pigment dispersant adsorbed to the yellow pigment. When the content of the pigment dispersant not adsorbed to the yellow pigment is 15% by mass or greater, the pigment dispersant adsorbed to the yellow pigment transfers to the dispersion medium (polymerizable compound), making it possible to realize a higher storage stability. When the content of the pigment dispersant not adsorbed to the pigment is 50% by mass or less, a higher storage stability can be realized.

The content of the pigment dispersant adsorbed to the pigment is not particularly limited, and is not only affected by the blending amount of the pigment dispersant and the physical properties of the pigment dispersant such as acid value and amine value but also may be appropriately selected depending on the particle diameter, the surface treated condition, and the dispersing conditions of the pigment.

The method for measuring the content of the pigment dispersant adsorbed to the pigment includes filling a centrifuge tube with the pigment dispersion composition (1 mL), centrifuging the pigment dispersion composition at 13,000 rpm for 90 minutes with a centrifuge (a desktop high-speed microcentrifuge TYPE CT13, available from Hitachi Koki Co., Ltd.) to separate solid components such as the pigment from the supernatant, removing the supernatant, performing a washing step of adding acetone up to a total of 1 mL, stirring the solid components with a spatula, and subjecting the resultant to ultrasonic dispersion for 20 minutes, repeating centrifugation and the washing step by acetone four times to obtain the solid components including no supernatant, determining the number of times to perform washing by observing the amount of the nonvolatile component in the supernatant, removing acetone from the obtained solid components at a reduced pressure at 25 degrees C. to extract the pigment to which the pigment dispersant is adsorbed, firing the collected pigment (100 mg) with an electric furnace (ROP-001, available from AS ONE Corporation) at 400 degrees C. for 60 minutes, and measuring the amount of weight reduction through the firing as the amount of the component adsorbed to the pigment. In this way, the content of the pigment dispersant adsorbed to the pigment can be measured.

The content of the pigment dispersant not adsorbed to the pigment can be measured by removing acetone from the supernatant.

### <Polymerizable Compound>

The polymerizable compound is a polymerizable compound having a solubility parameter (SP value) of 10.00 or greater, preferably a polymerizable compound having a solubility parameter of 10.15 or greater, and particularly preferably a polymerizable compound having a solubility parameter of 11.00 or greater. When the SP value of the polymerizable compound is 10.00 or greater, the polarity difference (SP value difference) between the polymerizable compound and the pigment dispersant is low. This makes adsorption of the pigment dispersant to the yellow pigment stable, making it possible to realize a high storage stability through a steric repulsion effect. This also improves dispersibility of the yellow pigment and makes the particle size distribution uniform, leading to reduction of excessively small particles and aggregating particles.

The solubility parameter, which is also referred to as “SP value”, means a value calculated according to Small's formula represented by formula (1) below.

σ=ρ·(τFi)/M Mathematical formula (1)

In Mathematical formula (1), σ represents SP value, ρ represents density, Fi represents mole constant of attraction, and M represents the molecular weight of a repeating unit (monomer) of a polymer.

Examples of the polymerizable compound having a SP value of 10.00 or greater include, but are not limited to, acryloylmorpholine (with a SP value of 11.55), methacryloylmorpholine, hydroxyethyl acrylamide (with a SP value of 15.63), hydroxyethyl methacrylamide, N-vinyl formamide (with a SP value of 11.01), 4-hydroxybutyl acrylate (with a SP value of 11.31), 4-hydroxybutyl methacrylate, phenoxydiethylene glycol acrylate (with a SP value of 10.01), phenoxydiethylene glycol methacrylate, methoxytetraethylene glycol acrylate (with a SP value of 10.15), methoxytetraethylene glycol methacrylate, pentaerythritol triacrylate (with a SP value of 10.25), pentaerythritol trimethacrylate, dicyclopentanyl dimethylene diacrylate (with a SP value of 10.34), dicyclopentanyl dimethylene dimethacrylate, dicyclopentanyloxy acrylate (with a SP value of 10.35), dicyclopentanyloxy methacrylate, dicyclopentenyloxyethyl acrylate (with a SP value of 10.44), dicyclopentenyloxyethyl methacrylate, cyclohexyl acrylate (with a SP value of 10.54), cyclohexyl methacrylate, N-vinyl caprolactam (with a SP value of 10.65), and compounds represented by Structural formula (1) below (with a SP value of 11.58). One of these polymerizable compounds may be used alone or two or more of these polymerizable compounds may be used in combination.

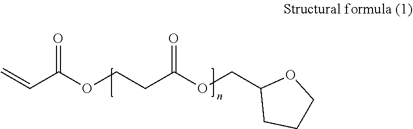

where n represents an integer of 1 or greater.

The content of the polymerizable compound having a SP value of 10.00 or greater is preferably 10% by mass or greater but 95% by mass or less, more preferably 15% by mass or greater but 90% by mass or less, and particularly preferably 20% by mass or greater but 85% by mass or less relative to the total amount of the pigment dispersion composition. The pigment dispersion composition may contain a polymerizable compound having a SP value of less than 10.00. However, the content of the polymerizable compound having a SP value of less than 10.00 is preferably 10% by mass or less relative to the total amount of the pigment dispersion composition.

### <Yellow Pigment>

The yellow pigment is not particularly limited and may be appropriately selected depending on the intended purpose. Examples of the yellow pigment include, but are not limited to, C.I. pigment yellow 74, C.I pigment yellow 138, C.I, pigment yellow 155, C.I. pigment yellow 151, C.I. pigment yellow 180, and C.I. pigment yellow 185. One of these yellow pigments may be used alone or two or more of these yellow pigments may be used in combination. Among these yellow pigments, C.I. pigment yellow 138 and C.I. pigment yellow 155 are preferable in terms of storage stability, and C.I pigment yellow 138 is more preferable.

The C.I. pigment yellow 138 has a chemical name 2,2′-(2,8-quinolinediyl)bis[4,5,6,7-tetrachloro-1H-isoindole-1,3(2H)-dione] and a molecular formula C₂₆H₆N₂O₄Cl₈. The C.I. pigment yellow 138 has an excellent hue, coloring power, and viscosity suppressibility to qualify as an inkjet pigment.

The C.I. pigment yellow 155 has a chemical name 22′-[1,4-phenylene-bis[imino(1-acetyl-2-oxoethane-2,1-diyl)azo]]bis(dimethyl terephthalate) and a molecular formula C₃₄H₃₂N₆O₁₂. The C.I. pigment yellow 155 is free of nickel and has an excellent safety. The C.I. pigment yellow 155 has a broad color gamut, a high coloring power, and a high weatherability, and is hence widely used in application fields under severe outdoor conditions.

A commercially available product can be used as the yellow pigment. Examples of the commercially available product include, but are not limited to, D1080J (C.I. pigment yellow 138, available from BASF Japan Ltd.), 4G (C.I, pigment yellow 138, available from Clariant Japan K.K.), 4GC (C.I. pigment yellow 155, available from Clariant Japan K.K.), P-HG (C.I. pigment yellow 180, available from Clariant Japan K.K.), BY2000GT (C.I. pigment yellow 180, available from DIC Corporation), and Fast Yellow 531 (C.I. pigment yellow 74, available from Dainichiseika Color & Chemicals Mfg. Co., Ltd.). One of these commercially available products may be used alone or two or more of these commercially available products may be used in combination.

The number average primary particle diameter of the yellow pigment is not particularly limited, may be appropriately selected depending on the intended purpose, and is preferably 30 nm or greater but 180 nm or less and more preferably 40 nm or greater but 150 nm or less. When the number average primary particle diameter of the yellow pigment is 30 nm or greater but 180 nm or less, dispersibility is improved.

The number average primary particle diameter can be obtained based on the average value of cumulative distribution of unidirectional particle diameters of 200 or more but 500 or less primary particles measured within the interval between two parallel lines extending in a certain direction and sandwiching the primary particles, using a scanning electron microscope (instrument name: SU3500, available from Hitachi High-Technologies Corporation) in a field of view of a 10,000 times magnification.

It is preferable to apply surface treatment to the surface of the yellow pigment.

The method for the surface treatment is not particularly limited and may be appropriately selected depending on the intended purpose. Examples of the method include, but are not limited to, known methods such as treatment with a pigment derivative, modification with a resin, acid treatment, and plasma treatment. The acid treatment makes a basic dispersant polymer more adsorbable to the yellow pigment, making it possible to improve dispersibility through a steric repulsion effect.

The content of the yellow pigment is preferably 1% by mass or greater but 20% by mass or less and more preferably 5% by mass or greater but 15% by mass or less relative to the total amount of the pigment dispersion composition. When the content of the yellow pigment is 1% by mass or greater, colorability is improved. When the content of the yellow pigment is 20% by mass or less, viscosity thickening is suppressed and discharging stability is improved.

### <Other Components>

The other components are not particularly limited and may be appropriately selected depending on the intended purpose. Examples of the other components include, but are not limited to, a polymerization inhibitor, a slipping agent (surfactant), a permeation enhancing agent, a wetting agent (humectant), a fixing agent, a fungicide, a preservative, an antioxidant, an ultraviolet absorbent, a chelate agent, a pH adjuster, and a thickener.

### <Viscosity>

The viscosity of the pigment dispersion composition of the present disclosure has no particular limit because it can be adjusted depending on the purpose and application devices. For example, if an ejecting device that ejects the composition from nozzles is employed, the viscosity thereof is preferably in the range of 3 mPa·s to 40 mPa·s, more preferably 5 mPa·s to 15 mPa·s, and particularly preferably 6 mPa·s to 12 mPa·s in the temperature range of 20 degrees C. to 65 degrees C., preferably at 25 degrees C. In addition, it is particularly preferable to satisfy this viscosity range by the composition free of the organic solvent described above.

Incidentally, the viscosity can be measured by a cone plate rotary viscometer (VISCOMETER TVE-22L, manufactured by TOKI SANGYO CO., LTD.) using a cone rotor (1° 34′×R24) at a number of rotation of 50 rpm with a setting of the temperature of hemathermal circulating water in the range of 20 degrees C. to 65 degrees C. VISCOMATE VM-150III can be used for the temperature adjustment of the circulating water.

The viscosity change ratio of the pigment dispersion composition is preferably 15% or lower, more preferably 10% or lower, and particularly preferably 5% or lower. When the viscosity change ratio is 15% or lower, the pigment dispersion composition has an excellent storage stability and an improved dispersibility. The viscosity change ratio can be calculated according to Mathematical formula (2) below. The viscosities in the viscosity change ratio can be measured by a cone plate rotary viscometer (instrument name: VISCOMETER TV-22, manufactured by TOKI SANGYO CO., LTD.) with a setting of the temperature of hemathermal circulating water at 25 degrees C. at a number of rotation of 50 rpm at a shear velocity of 191.4 sec⁻¹.

Viscosity change ratio (%)=((viscosity after storage at 70 degrees C. for 14 days−initial viscosity)/initial viscosity)×100 Mathematical formula (2)

### <50% Cumulative Volume-Based Particle Diameter and Distribution Width of Particle Size Distribution>

In the present disclosure, the 50% cumulative volume-based particle diameter of the pigment in the pigment dispersion composition is preferably 100 nm or greater but 160 nm or less, and the distribution width of the particle size distribution calculated according to Mathematical formula (3) below is preferably 60 nm or less.

Distribution width of particle size distribution=(84% cumulative volume-based particle diameter−16% cumulative volume-based particle diameter)/2 Mathematical formula (3)

When the 50% cumulative volume-based particle diameter is 100 nm or greater but 160 nm or less, effects of improving dispersibility and improving liquid permeability and discharging stability are achieved.

When the distribution width of the particle size distribution calculated according to Mathematical formula (3) above is 60 nm or less, an effect of improving liquid permeability and discharging stability is achieved with a sharp dispersed particle diameter.

The 50% cumulative volume-based particle diameter is more preferably 100 nm or greater but 140 nm or less.

The distribution width of the particle size distribution calculated according to Mathematical formula (3) above is more preferably 50 nm or less.

The 50% cumulative volume-based particle diameter (D50) and the distribution width of the particle size distribution can be obtained in the manners described below.

The 50% cumulative volume-based particle diameter (D50) is measured with a particle size distribution analyzer (product name: UPA150, available from Nikkiso Co., Ltd.) with dilution of the obtained curable composition about 2,000-fold with the polymerizable compound used as the dispersion medium.

The distribution width of the particle size distribution can be calculated according to Mathematical formula (3) above with measurement of the 84% cumulative volume-based particle diameter (D84) and the 16% cumulative volume-based particle diameter (D16) in the same manner as the 50% cumulative volume-based particle diameter (D50).

### <Producing Method>

Examples of the method for producing the pigment dispersion composition include, but are not limited to, a method of mixing the yellow pigment, the pigment dispersant, and the polymerizable compound and subjecting the resultant to dispersion using a dispersing machine. Examples of the dispersing machine include, but are not limited to, dispersing machines using media, such as a ball mill, a sand mill, and a bead mill, and medialess dispersing machines. As the method for dispersing, a method of dispersing the components in a state under a high pigment concentration that is about two times higher than the intended pigment concentration of the dispersion, and diluting the resultant with the dispersion medium (polymerizable compound) to the intended pigment concentration before extracting the dispersion is effective. In the state under a high pigment concentration, it is expected that the ratio of the pigment to the dispersant polymer is high, to provide more chances of contact between the dispersant polymer and the pigment, and promote adsorption of the dispersant polymer to the pigment.

As the dispersion media of the dispersing machine using media, it is preferable to use zirconia beads in terms of dispersibility and dispersion efficiency. Two or more dispersing methods may be used in combination. For example, ball mill dispersion can obtain a dispersion liquid having a uniform particle size distribution through two-step dispersion including dispersion using zirconia beads having a diameter of 5 mm and dispersion using zirconia beads having a diameter of 1 mm.

The medialess dispersing machine will not apply excessive energy to the pigment and can prevent the pigment particles from, for example, being crushed, making it possible to promote adsorption of the dispersant polymer to the surface of the pigment and improve storage stability. Moreover, the medialess dispersing machine prevents not only overdispersion but also contamination attributable to the media, making it possible to suppress occurrence of fine particles and coarse particles in the system. These factors help improve the uniformity of the particle size distribution and obtain a high ink discharging stability.

Examples of the medialess dispersing machine include, but are not limited to, dispersing machines using a high-speed shear force based on, for example, impact dispersion and ultrasonic dispersion, and dispersing machines using high-speed stirring.

Examples of the dispersing machines using a high-speed shear force include, but are not limited to, machine name: NANOVEITA SERIES LABORATORY MACHINE C-ES008 (available from Yoshida Kikai Co., Ltd.).

The temperature of the dispersion liquid during dispersion is preferably 5 degrees C. or higher but 60 degrees C. or lower. When the temperature is 5 degrees C. or higher but 60 degrees C. or lower, a curing reaction of the monomer can be suppressed. It is also possible to previously add a polymerization inhibitor in a low amount in order to suppress a curing reaction.

### <Application Field>

The application field of the pigment dispersion composition of the present disclosure is not particularly limited and may be appropriately selected depending on the intended purpose. Examples of the application field include, but are not limited to, curable compositions, curable inks, and paints. The pigment dispersion composition of the present disclosure is suitably used as the pigment dispersion composition for a curable composition described below.

### (Curable Composition)

A curable composition (hereinafter may be referred to as “curable ink”) of the present disclosure contains the pigment dispersion composition of the present disclosure described above, preferably contains a polymerizable compound and a polymerization initiator, and further contains other components as needed.

The content of the pigment dispersion composition is preferably 10% by mass or greater but 50% by mass or less and more preferably 15% by mass or greater but 30% by mass or less relative to the total amount of the curable composition.

The curable composition can be prepared by further mixing the pigment dispersion composition of the present disclosure with a polymerizable compound, a polymerization initiator, a polymerization inhibitor, and a surfactant as needed.

### <Polymerizable Compound>

The polymerizable compound is not particularly limited and may be appropriately selected depending on the intended purpose so long as the polymerizable compound is allowed to undergo a polymerization reaction in response to heat or active energy rays (e.g., ultraviolet rays and electron beams). One polymerizable compound may be used alone or two or more polymerizable compounds may be used in combination in terms of adjusting, for example, a reaction speed, ink properties, and cured film properties.

Examples of the polymerizable compound include, but are not limited to, a radical-polymerizable polymerizable compound and a polymerizable oligomer.

Examples of the radical-polymerizable polymerizable compound include, but are not limited to, a (meth)acrylate compound, a (meth)acrylamide compound, and an aromatic vinyl compound. One of these radical-polymerizable polymerizable compounds may be used alone or two or more of these radical-polymerizable polymerizable compounds may be used in combination. (Meth)acrylate as used herein refers to at least one of acrylate and methacrylate, and (meth)acrylic refers to at least one of acrylic and methacrylic.

### <<(Meth)acrylate Compound>>

Examples of the (meth)acrylate compounds include, but are not limited to, monofunctional (meth)acrylates, bifunctional (meth) acrylates, trifunctional (meth)acrylates, tetrafunctional (meth)acrylates, pentafunctional (meth)acrylates, and hexafunctional (meth)acrylates. One of these (meth)acrylate compounds may be used alone or two or more of these (meth)acrylate compounds may be used in combination.

Examples of the monofunctional (meth)acrylate include, but are not limited to, hexyl(meth)acrylate, 2-ethylhexyl (meth)acrylate, tert-octyl (meth)acrylate, isoamyl (meth)acrylate, decyl (meth)acrylate, isodecyl (meth)acrylate, stearyl (meth)acrylate, isostearyl (meth)acrylate, cyclohexyl (meth)acrylate, 4-n-butylcyclohexyl (meth)acrylate, bornyl (meth)acrylate, isobornyl (meth)acrylate, benzyl (meth)acrylate, butoxyethyl (meth)acrylate, 2-chloroethyl (meth)acrylate, 4-bromobutyl (meth)acrylate, cyanoethyl (meth)acrylate, benzyl(meth)acrylate, butoxymethyl (meth)acrylate, 3-methoxybutyl (meth)acrylate, alkoxymethyl (meth)acrylate, alkoxyethyl (meth)acrylate, 2-(2-methoxyethoxy)ethyl (meth)acrylate, 2-(2-butoxyethoxy)ethyl (meth)acrylate, 2,2,2-tetrafluoroethyl (meth)acrylate, 1H,1H,2H,2H-perfluorodecyl (meth)acrylate, 4-butylphenyl (meth)acrylate, phenyl (meth)acrylate, 2,4,5-tetramethylphenyl (meth)acrylate, 4-chlorophenyl (meth)acrylate, phenoxymethyl (meth)acrylate, phenoxyethyl (meth)acrylate, glycidyl (meth)acrylate, glycidyloxybutyl (meth)acrylate, glycidyloxyethyl (meth)acrylate, glycidyloxypropyl (meth)acrylate, tetrahydrofurfuryl (meth)acrylate, hydroxyalkyl (meth)acrylate, 2-hydroxyethyl (meth)acrylate, 3-hdyroxypropyl (meth)acrylate, 2-hydroxypropyl (meth)acrylate, 2-hydroxybutyl (meth)acrylate, 4-hydroxybutyl (meth)acrylate, dimethylaminoethyl (meth)acrylate, diethylaminoethyl (meth)acylate, dimethylaminopropyl (meth)acrylate, diethylaminopropyl (meth)acrylate, trimethoxysilylpropyl (meth)acrylate, trimethylsilylpropyl (meth)acrylate, polyethylene oxide monomethyl ether (meth)acrylate, oligoethylene oxide monomethy ether (meth)acrylate, polyethylene oxide (meth)acrylate, oligoethylene oxide (meth)acrylate, oligoethylene oxide monoalkyl ether (meth)acrylate, polyethylene oxide monoalkyl ether (meth)acrylate, dipropylene glycol (meth)acrylate, polypropylene oxide monoalkyl ether (meth)acrylate, oligopropylene oxide monoalkyl ether (meth)acrylate, 2-methacryloyloxyethyl succinic acid, 2-methacryloyloxyhexahydrophthalic acid, 2-methacryloyloxyethyl-2-hydroxypropyl phthalate, butoxydiethylene glycol (meth)acrylate, trifluoroethyl (meth)acrylate, perfluorooctylethyl (meth)acrylate, 2-hydroxy-3-phenoxypropyl (meth)acrylate, ethylene oxide-modified phenol (meth)acrylate, ethylene oxide-modified cresol (meth)acrylate, ethylene oxide-modified nonylphenol (meth)acrylate, propylene oxide-modified nonylphenol (meth)acrylate, ethylene oxide-modified-2-ethylhexyl (meth)acrylate, acrylic acid-2-(2-vinyloxyethoxy)ethyl, and benzyl acrylate. One of these monofunctional (meth)acrylates may be used alone or two or more of these monofunctional (meth)acrylates may be used in combination. Among these monofunctional (meth)acrylates, phenoxyethyl (meth)acrylate, benzyl acrylate, acrylic acid-2-(2-vinyloxyethoxy)ethyl, 2-hydroxyethyl (meth)acrylate, 3-hydroxypropyl (meth)acrylate, 2-hydroxylpropyl (meth)acrylate, and 4-hydroxybutyl (meth)acrylate are preferable in terms of low viscosity, low odor, and high curability, and phenoxyethyl (meth)acrylate, benzyl acrylate, and acrylic acid-2-(2-vinyloxyethoxy)ethyl are particularly preferable in terms of compatibility with a photopolymerization initiator and other monomers.

Examples of the bifunctional (meth)acrylate include, but are not limited to, 1,6-hexanediol di(meth)acrylate, 1,10-decanediol di(meth)acrylate, neopentyl glycol di(meth)acrylate, 2,4-dimethyl-1,5-pentanediol di(meth)actylate, butylethylpropanediol (meth)acrylate, ethoxylated cyclohexanemethanol di(meth)acrylate, polyethylene glycol di(meth)acrylate, oligoethylene glycol di(meth)acrylate, ethylene glycol di(meth)acrylate, 2-ethyl-2-butyl-butanediol di(meth)acrylate, hydroxypivalic acid neopentyl glycol di(meth)acrylate, ethylene oxide-modified bisphenol A di(meth)acrylate, bisphenol F polyethoxy di(meth)acrylate, polypropylene glycol di(meth)acrylate, oligopropylene glycol di(meth)acrylate, 1,4-butanediol di(meth)acrylate, 2-ethyl-2-butylpropanediol di(meth)acrylate, 1,9-nonane di(meth)acrylate, propoxylated ethoxylated bisphenol A di(meth)acrylate, and tricyclodecane di(meth)acrylate. One of these bifunctional (meth)acrylates may be used alone or two or more of these bifunctional (meth)acrylates may be used in combination.

Examples of the trifunctional (meth)acrylate include, but are not limited to, trimethylolpropane tri(meth)acrylate, trimethylolethane tri(meth)acrylate, trimethylolpropane alkylene-oxide-modified tri(meth)acrylate, pentaerythritol tri(meth)acrylate, dipentaerythritol tri(meth)acrylate, trimethylolpropane tri((meth)acryloyloxypropyl)ether, isocyanuric acid alkylene-oxide-modified tri(meth)acrylate, propionic acid dipentaerythritol tri(meth)acrylate, tri((meth)acryloyloxyethyl)isocyanurate, hydroxypivalaldehyde-modified dimethylolpropane tri(meth)acrylate, sorbitol tri(meth)acrylate, propoxylated trimethylolpropane tri(meth)acrylate, and ethoxylated glycerin tri(meth)acrylate. One of these trifunctional (meth)acrylates may be used alone or two or more of these trifunctional (meth)acrylates may be used in combination.

Examples of the tetrafunctional (meth)acrylate include, but are not limited to, pentaerythitol tetra(meth)acrylate, sorbitol tetra(meth)acrylate, ditrimethylolpropane tetra(meth)acrylate, propionic acid dipentaerythritol tetra(meth)acrylate, and ethoxylated pentaerythritol tetra(meth)acrylate. One of these tetrafunctional (meth)acrylates may be used alone or two or more of these tetrafunctional (meth)acrylates may be used in combination.

Examples of the pentafunctional (meth)acrylate include, but are not limited to, sorbitol penta(meth)acrylate and dipentaerythritol penta(meth)acrylate. One of these pentafunctional (meth)acrylates may be used alone or two or more of these pentafunctional (meth)acrylates may be used in combination.

Examples of the hexafunctional (meth)acrylate include, but are not limited to, dipentaerythritol hexa(meth)acrylate, sorbitol hexa(meth)acrylate, phosphazene alkylene-oxide-modified hexa(meth)acrylate, and caprolactone-modified dipentaerythritol hexa(meth)acrylate. One of these hexafunctional (meth)acrylates may be used alone or two or more of these hexafunctional (meth)acrylates may be used in combination.

### <<(Meth)acrylamide Compound>>

Examples of the (meth)acrylamide compound include, but are not limited to, (meth)acrylamide, N-methyl (meth)acrylamide, N-ethyl (meth)acrylamide, N-propyl (meth)acrylamide, N-n-butyl (meth)acrylamide, N-t-butyl (meth)acrylamide, N-butoxymethyl (meth)acrylamide, N-isopropyl (meth)acrylamide, N-methylol (meth)acrylamide, N,N-dimethyl (meth)acrylamide, N,N-diethyl (meth)acrylamide, (meth)acryloylmorpholine, and hydroxyethyl (meth)acrylamide. One of these (meth)acrylamide compounds may be used alone or two or more of these (meth)acrylamide compounds may be used in combination.

Among these (meth)acrylamide compounds, (meth)acryloylmorpholine is preferable.

### <<Aromatic Vinyl Compound>>

Examples of the aromatic vinyl compound include, but are not limited to, styrene, methyl styrene, dimethyl styrene, trimethyl styrene, ethyl styrene, isopropyl styrene, chloromethyl styrene, methoxystyrene, acetoxystyrene, chlorostyrene, dichlorostyrene, bromostyrene, vinyl benzoic acid methyl ester, 3-methyl styrene, 4-methyl styrene, 3-ethyl styrene, 4-ethyl styrene, 3-propyl styrene, 4-propyl styrene, 3-butyl styrene, 4-butyl styrene, 3-hexyl styrene, 4-hexyl styrene, 3-octyl styrene, 4-octyl styrene, 3-(2-ethylhexyl)styrene, 4-(2-ethylhexyl)styrene, allyl styrene, isopropenyl styrene, butenyl styrene, octenyl styrene, 4-t-butoxycarbonyl styrene, 4-methoxystyrene, and 4-t-butoxystyrene. One of these aromatic vinyl compounds may be used alone or two or more of these aromatic vinyl compounds may be used in combination.

### <<Polymerizable Oligomer>>

It is preferable that the polymerizable oligomer contain one or more ethylenically unsaturated double bonds. An oligomer means a polymer containing 2 or more but 20 or less monomer structure repeating units.

The weight average molecular weight of the polymerizable oligomer is not particularly limited, may be appropriately selected depending on the intended purpose, and is preferably 1,000 or greater but 30,000 or less and more preferably 5,000 or greater but 20,000 or less by polystyrene equivalent. The weight average molecular weight can be measured by, for example, gel permeation chromatography (GPC).

Examples of the polymerizable oligomer include, but are not limited to, urethane acrylic oligomer (e.g., aromatic urethane acrylic oligomers and aliphatic urethane acrylic oligomers), epoxy acrylate oligomers, polyester acrylate oligomers, and other special oligomers. One of these polymerizable oligomers may be used alone or two or more of these polymerizable oligomers may be used in combination. Among these polymerizable oligomers, oligomers containing two or more but five or less unsaturated carbon-carbon bonds are preferable, and oligomers containing two unsaturated carbon-carbon bonds are more preferable. When the number of unsaturated carbon-carbon bonds is two or more but five or less, a good curability can be obtained.

An appropriately synthesized product or a commercially available product may be used as the polymerizable oligomer. Examples of the commercially available product include, but are not limited to, UV-2000B, UV-2750B, UV-3000B, UV-300B, UV-3200B, UV-3300B, UV-3700B, UV-6640B, UV-8630B, UV-7000B, UV-7610B, UV-1700B, UV-7630B, UV-6300B, UV-6640B, UV-7550B, UV-7600B, UV-7605B, UV-7610B, UV-7630B, UV-7640B, UV-7650B, UT-5449, and UT-5454 available from Nippon Synthetic Chemical Industry Co., Ltd.; CN902, CN902375, CN929, CN940, CN944, CN944B85, CN959, CN961E75, CN961H81, CN962, CN963, CN963A80, CN963B80, CN963E75, CN963E80, CN963J85, CN964, CN %5, CN965A80, CN966, CN966A80, CN966B85, CN966H90, CN966J75, CN %8, CN %9, CN970, CN970A60, CN970E60, CN971, CN971A80, CN971J75, CN972, CN973, CN973A80, CN973H85, CN973J75, CN975, CN977, CN977C70, CN978, CN980, CN981, CN981A75, CN981B88, CN982, CN982A75, CN982B88, CN982E75, CN983, CN984, CN985, CN985B88, CN986, CN989, CN991, CN992, CN994, CN996, CN997, CN999, CN9001, CN9002, CN9004, CN9005, CN9006, CN9007, CN9008, CN9009, CN9010, CN9011, CN9013, CN9018, CN9019, CN9024, CN9025, CN9026, CN9028, CN9029, CN9030, CN9060, CN9165, CN9167, CN9178, CN9290, CN9782, CN9783, CN9788, and CN9893 available from Sartomer USA, LLC; and EBECRYL210, EBECRYL220, EBECRYL230, EBECRYL270, KRM8200, EBECRYL5129, EBECRYL8210, EBECRYL8301, EBECRYL8804, EBECRYL8807, EBECRYL9260, KRM7735, KRM8296, KRM8452, EBECRYL4858, EBECRYL8402, EBECRYL9270, EBECRYL8311, and EBECRYL8701 available from Daicel-Cytec Co., Ltd. One of these commercially available products may be used alone or two or more of these commercially available products may be used in combination.

### <Polymerization Initiator>

Examples of the polymerization initiator include, but are not limited to, a photopolymerization initiator and a thermal polymerization initiator. Of these polymerization initiators, a photopolymerization initiator is preferable.

The photopolymerization initiator produces active species such as a radical or a cation upon application of energy of an active energy ray and initiates polymerization of a polymerizable compound (monomer or oligomer). As the polymerization initiator, it is suitable to use a known radical polymerization initiator, cation polymerization initiator, or a combination thereof. Of these, a radical polymerization initiator is preferable. Moreover, the polymerization initiator preferably accounts for 5 percent by weight to 20 percent by weight of the total content of the pigment dispersion composition to obtain sufficient curing speed.

Specific examples of the radical polymerization initiators include, but are not limited to, aromatic ketones, acylphosphine oxide compounds, aromatic onium chlorides, organic peroxides, thio compounds (thioxanthone compounds, thiophenyl group containing compounds, etc.), hexaaryl biimidazole compounds, ketoxime ester compounds, borate compounds, azinium compounds, metallocene compounds, active ester compounds, compounds having a carbon halogen bond(s), and alkyl amine compounds. One of these radical polymerization initiators may be used alone or two or more of these radical polymerization initiators may be used in combination.

In addition, a polymerization accelerator is optionally used together with the polymerization initiator.

The polymerization accelerator is not particularly limited. Examples of the polymerization accelerator include, but are not limited to, amine compounds such as ethyl p-dimethylaminobenzoate, p-dimethylaminobenzoic acid-2-ethyl hexyl, methyl p-dimethylaminobenzoate, benzoic acid-2-dimethylaminoethyl, and butoxyethyl p-dimethylaminobenzoate. One of these polymerization accelerators may be used alone or two or more of these polymerization accelerators may be used in combination.

The thermal polymerization initiator is not particularly limited and may be appropriately selected depending on the intended purpose. Examples of the thermal polymerization initiator include, but are not limited to, azo-based initiators, peroxide initiators, persulfate initiators, and redox (oxidoreduction) initiators.

### <Other Components>

The other components are not particularly limited and may be appropriately selected depending on the intended purpose. Examples of the other components include, but are not limited to, a polymerization inhibitor, a surfactant, and an organic solvent.

### <<Polymerization Inhibitor>>

Examples of the polymerization inhibitor include, but are not limited to, p-methoxyphenol, 4-methoxy-1-naphthol, methyl hydroquinone, hydroquinone, t-butyl hydroquinone, di-t-butyl hydroquinone, methoquinone, 2,2′-dihydroxy-3,3′-di(α-methylcyclohexyl)-5,5′-dimethyldiphenylmethane, p-benzoquinone, di-t-butyldiphenylamine, 9,10-di-n-butoxyanthracene, and 4,4′-[1,10-dioxo-1,10-decanediylbis(oxy)] bis[2,2,6,6-tetramethyl]-1-piperidinyloxy.

The content of the polymerization inhibitor is preferably 0.005% by mass or greater but 3% by mass or less relative to the total amount of the polymerization initiator. When the content of the polymerization inhibitor is 0.005% by mass or greater, storage stability is improved and viscosity thickening in a high-temperature environment can be suppressed. When the content of the polymerization inhibitor is 3% by mass or less, curability is improved.

### <<Surfactant>>

The surfactant is not particularly limited and may be appropriately selected depending on the intended purpose. Examples of the surfactant include, but are not limited to, higher fatty acid-based surfactants, silicone-based surfactants, and fluorosurfactants.

The content of the surfactant is preferably 0.1% by mass or greater but 3% by mass or less and more preferably 0.2% by mass or greater but 1% by mass or less relative to the total amount of the pigment dispersion composition. When the content of the surfactant is 0.1% by mass or greater, wettability can be improved. When the content of the surfactant is 3% by mass or less, curability can be improved. When the content is in the more preferable range, wettability and a leveling property can be improved.

### <<Organic Solvent>>

The pigment dispersion composition of the present disclosure optionally contains an organic solvent although it is preferable to spare it. The composition free of an organic solvent, in particular volatile organic compound (VOC), is preferable because it enhances safety at where the composition is handled and makes it possible to prevent pollution of the environment. Incidentally, the organic solvent represents a conventional non-reactive organic solvent, for example, ether, ketone, xylene, ethyl acetate, cyclohexanone, and toluene, which is clearly distinguished from reactive monomers. Furthermore, “free of” an organic solvent means that no organic solvent is substantially contained. The content thereof is preferably less than 0.1 percent by mass.

The static surface tension of the curable ink at 25 degrees C. is preferably 20 mN/m or higher but 40 mN/m or lower and more preferably 28 mN/m or higher but 35 mN/m or lower.

The static surface tension is measured with a static surface tensionmeter (available from Kyowa Interface Science Co., Ltd., CBVP-Z TYPE) at 25 degrees C. The specifications of commercially available inkjet discharging heads such as GENS available from Ricoh Printing Systems, Ltd. are assumed for the static surface tension.

### <Viscosity>

The viscosity of the curable composition of the present disclosure has no particular limit because it can be adjusted depending on the purpose and application devices. For example, if an ejecting device that ejects the composition from nozzles is employed, the viscosity thereof is preferably in the range of 3 mPa·s to 40 mPa·s, more preferably 5 mPa·s to 15 mPa·s, and particularly preferably 6 mPa·s to 12 mPa·s in the temperature range of 20 degrees C. to 65 degrees C., preferably at 25 degrees C. In addition, it is particularly preferable to satisfy this viscosity range by the composition free of the organic solvent described above. Incidentally, the viscosity can be measured by a cone plate rotary viscometer (VISCOMETER TVE-22L, manufactured by TOKI SANGYO CO., LTD.) using a cone rotor (1°34′×R24) at a number of rotation of 50 rpm with a setting of the temperature of hemathermal circulating water in the range of 20 degrees C. to 65 degrees C. VISCOMATE VM-150H can be used for the temperature adjustment of the circulating water.

The viscosity change ratio of the curable composition is preferably 15% or lower, more preferably 10% or lower, and particularly preferably 5% or lower. When the viscosity change ratio is 15% or lower, the curable composition has an excellent storage stability and an improved dispersibility. The viscosity change ratio can be calculated according to Mathematical formula (4) below. The viscosities in the viscosity change ratio can be measured by a cone plate rotary viscometer (instrument name: VISCOMETER TV-22, manufactured by TOKI SANGYO CO., LTD.) with a setting of the temperature of hemathermal circulating water at 25 degrees C. at a number of rotation of 50 rpm at a shear velocity of 191.4 sec⁻¹.

Viscosity change ratio (%)=((viscosity after storage at 70 degrees C. for 14 days−initial viscosity)initial viscosity)×100 Mathematical formula (4)

### <Application Field>

The application field of the curable composition of the present disclosure is not particularly limited. It can be applied to any field where active-energy-ray-curable compositions are used. For example, the curable composition is selected to a particular application and used for a resin for processing, a paint, an adhesive, an insulant, a releasing agent, a coating material, a sealing material, various resists, and various optical materials.

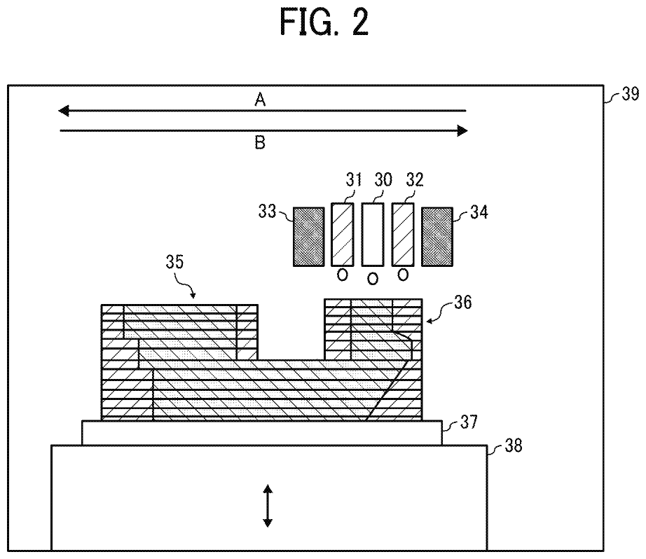

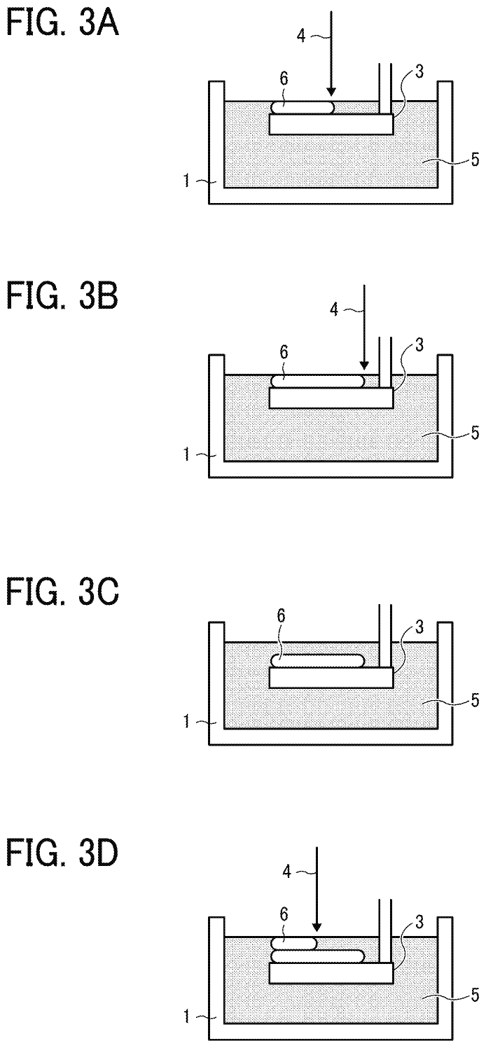

Furthermore, the curable composition of the present disclosure can be used as an ink to form two-dimensional texts, images, and designed coating film on various substrates and in addition as a solid object forming material to form a three-dimensional object. This three dimensional object forming material may also be used as a binder for powder particles used in a powder layer laminating method of forming a three-dimensional object by repeating curing and layer-forming of powder layers, and as a three-dimensional object constituent material (a model material) and a supporting member used in an additive manufacturing method (a stereolithography method) as illustrated in FIG. 2, FIG. 3A, FIG. 38, FIG. 3C, and FIG. 3D. FIG. 2 is a diagram illustrating a method of additive manufacturing to sequentially form layers of the curable composition of the present disclosure one on top of the other by repeating discharging the curable composition to particular areas followed by curing upon irradiation of an active energy ray (to be described in detail below). FIGS. 3A to 3D are each a diagram illustrating a method of additive manufacturing to sequentially form cured layers 6 having respective predetermined forms one on top of the other on a movable stage 3 by irradiating a storing pool (storing part) 1 of the curable composition 5 of the present disclosure with the active energy ray 4.

An apparatus for fabricating a three-dimensional object by the curable composition of the present disclosure is not particularly limited and can be a known apparatus. For example, the apparatus includes a containing device, a supplying device, and a discharging device of the curable composition, and an active energy ray irradiator.

In addition, the present disclosure includes cured materials obtained by curing the curable composition and processed products obtained by processing structures having the cured materials on a substrate. The processed product is fabricated by, for example, heat-drawing and punching a cured material or structure having a sheet-like form or film-like form. Examples thereof are products that need processing after decoration of the surface, such as gauges or operation panels of vehicles, office machines, electric and electronic machines, and cameras.

The substrate is not particularly limited. It can suitably be selected to a particular application. Examples thereof include paper, thread, fiber, fabrics, leather, metal, plastic, glass, wood, ceramic, or composite materials thereof. Of these, plastic substrates are preferred in terms of processability.

### (Stored Container)

A stored container (hereinafter, may also be referred to as “composition stored container”) of the present disclosure contains the curable composition and is suitable for the applications as described below. For example, if the curable composition of the present disclosure is used for ink, a container that stores the ink can be used as an ink cartridge or an ink bottle. Therefore, users can avoid direct contact with the ink during operations such as transfer or replacement of the ink, so that fingers and clothes are prevented from contamination. Furthermore, inclusion of foreign matters such as dust in the ink can be prevented. In addition, the container can be of any size, any form, and any material. For example, the container can be designed to a particular application. It is preferable to use a light blocking material to block the light or cover a container with a light blocking sheet, etc.

### (Image Forming Method and Forming Apparatus)

An image forming apparatus of the present disclosure is a two-dimensional or three-dimensional image forming apparatus.

The image forming apparatus of the present disclosure includes a storing part that stores the curable composition of the present disclosure, an applying unit configured to apply the curable composition, and a curing unit configured to cure the curable composition, and further includes other units as needed.

An image forming method of the present disclosure is a two-dimensional or three-dimensional image forming method.

The image forming method of the present disclosure includes an applying step of applying the curable composition of the present disclosure and a curing step of curing the curable composition, and further includes other steps as needed.

The image forming method of the present disclosure can be suitably performed by the image forming apparatus of the present disclosure. The applying step can be performed by the applying unit. The curing step can be performed by the curing unit. The other steps can be performed by the other units.

### <Storing Part>

The storing part is not particularly limited so long as the storing part can store the curable composition of the present disclosure, and may be appropriately selected depending on the intended purpose. The stored container described above is preferable.

### <Applying Unit and Applying Step>

The applying step is not particularly limited and may be appropriately selected depending on the intended purpose. Examples of the applying step include, but are not limited to, a discharging step. A discharging unit is not particularly limited. Examples of the discharging unit include, but are not limited to, a continuous jetting type and an on-demand type. Examples of the on-demand type include, but are not limited to, a piezo type, a thermal type, and an electrostatic type.

### <Curing Unit and Curing Step>

The curing step is not particularly limited so long as the curable composition of the present disclosure can be cured, and may be appropriately selected depending on the intended purpose. Examples of the curing step include, but are not limited to, a heating step, and an active energy ray irradiation step. Of these steps, the curing step by the active energy rays is preferable.

Examples of the method for curing the curable composition of the present disclosure include, but are not limited to, curing by heating and curing by active energy rays. Of these methods, curing by active energy rays is preferable.

Active energy rays used for curing the active-energy-ray-curable composition of the present disclosure are not particularly limited, so long as they are able to give necessary energy for allowing polymerization reaction of polymerizable components in the composition to proceed. Examples of the active energy rays include, but are not limited to, electron beams, α-rays, ß-rays, γ-rays, and X-rays, in addition to ultraviolet rays. When a light source having a particularly high energy is used, polymerization reaction can be allowed to proceed without a polymerization initiator. In addition, in the case of irradiation with ultraviolet rays, mercury-free is preferred in terms of protection of environment. Therefore, replacement with GaN-based semiconductor ultraviolet light-emitting devices is preferred from industrial and environmental point of view. Furthermore, ultraviolet light-emitting diode (UV-LED) and ultraviolet laser diode (UV-LD) are preferable as an ultraviolet light source. Small sizes, long time working life, high efficiency, and high cost performance make such irradiation sources desirable.

### <Other Units and Other Steps>

The other steps are not particularly limited and may be appropriately selected depending on the intended purpose.

The other units are not particularly limited and may be appropriately selected depending on the intended purpose.

The image forming apparatus of the present disclosure will be described with reference to the drawings.

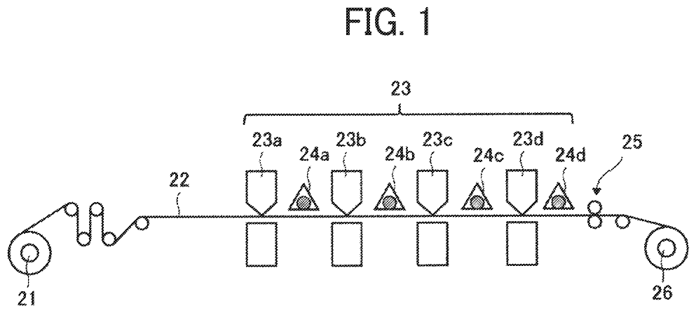

FIG. 1 is a diagram illustrating a two-dimensional image forming apparatus equipped with an inkjet discharging device. Printing units 23a, 23b, 23c, and 23d respectively having ink cartridges and discharging heads for yellow, magenta, cyan, and black curable inks discharge the inks onto a recording medium 22 fed from a supplying roller 21. Thereafter, light sources 24a, 24b, 24c, and 24d configured to cure the inks emit active energy rays to the inks, thereby curing the inks to form a color image. Thereafter, the recording medium 22 is conveyed to a processing unit 25 and a printed matter reeling roll 26. Each of the printing unit 23a, 23b, 23c and 23d may have a heating mechanism to liquidize the ink at the ink discharging portion. Moreover, in another embodiment of the present disclosure, a mechanism may optionally be included to cool down the recording medium to around room temperature in a contact or non-contact manner. In addition, the inkjet recording method may be either of serial methods or line methods. The serial methods include discharging an ink onto a recording medium by moving the head while the recording medium intermittently moves according to the width of a discharging head. The line methods include discharging an ink onto a recording medium from a discharging head held at a fixed position while the recording medium continuously moves.

The recording medium 22 is not particularly limited. Specific examples thereof include, but are not limited to, paper, film, metal, or complex materials thereof. The recording medium 22 takes a sheet-like form but is not limited thereto. The image forming apparatus may have a one-side printing configuration and/or a two-side printing configuration.

Optionally, multiple colors can be printed with no or weak active energy ray from the light sources 24a, 24b, and 24c followed by irradiation of the active energy ray from the light source 24d. As a result, energy and cost can be saved.

The recorded matter having images printed with the ink of the present disclosure includes articles having printed images or texts on a plain surface of conventional paper, resin film, etc., a rough surface, or a surface made of various materials such as metal or ceramic. in addition, by laminating layers of images in part or the entire of a recording medium, a partially stereoscopic image (formed of two dimensional part and three-dimensional part) and a three dimensional objects can be fabricated.

FIG. 2 is a schematic diagram illustrating another example of the image forming apparatus (apparatus to fabricate a 3D object) of the present disclosure. An image forming apparatus 39 illustrated in FIG. 2 sequentially forms thin layers one on top of the other using a head unit having inkjet heads arranged movable in the directions indicated by the arrows A and B. In the image forming apparatus 39, an ejection head unit 30 for additive manufacturing ejects a first curable composition, and ejection head units 31 and 32 for support and curing these compositions ejects a second curable composition having a different composition from the first curable composition, while ultraviolet irradiators 33 and 34 adjacent to the ejection head units 31 and 32 cure the compositions. To be more specific, for example, after the ejection head units 31 and 32 for support eject the second curable composition onto a substrate 37 for additive manufacturing and the second curable composition is solidified by irradiation of an active energy ray to form a first substrate layer having a space for composition, the ejection head unit 30 for additive manufacturing ejects the first curable composition onto the pool followed by irradiation of an active energy ray for solidification, thereby forming a first additive manufacturing layer. This step is repeated multiple times lowering the stage 38 movable in the vertical direction to laminate the supporting layer and the additive manufacturing layer to fabricate a solid object 35. Thereafter, an additive manufacturing support 36 is removed, if desired. Although only a single ejection head unit 30 for additive manufacturing is provided to the image forming apparatus illustrated in FIG. 2, it can have two or more units 30.

### (Cured Product)

A cured product of the present disclosure is a two-dimensional or three-dimensional image. The two-dimensional or three-dimensional image is obtained by applying the curable composition of the present disclosure over a base material and curing the curable composition.

The two-dimensional or three-dimensional image includes articles printed on a plain surface of conventional paper, resin film, etc., a rough surface, or a surface made of various materials such as metal or ceramic.

Examples of the two-dimensional image include, but are not limited to, letters, symbols, and diagrams, or combinations thereof, and solid images.

Examples of the three-dimensional image include, but are not limited to, a three-dimensional object.

The average thickness of the three-dimensional object is not particularly limited, may be appropriately selected depending on the intended purpose, and is preferably 10 micrometers or greater.

It is preferable to cure the two-dimensional or three-dimensional image with light from a light-emitting diode having an active energy ray irradiation intensity of 500 mJ/cm².

A tensile property of the cured product of the present disclosure at 180 degrees C., expressed by a ratio (length after tensile test-length before tensile test)/(length before tensile test), is preferably 50% or higher and more preferably 100% or higher.

### (Decorated Product)

A decorated product includes a base material and a surface decoration applied over the base material and formed of a cured product.

The same product as the cured product of the present disclosure can be used as the cured product.

The base material is not particularly limited. It can suitably be selected to a particular application. Examples thereof include paper, thread, fiber, fabrics, leather, metal, plastic, glass, wood, ceramic, or composite materials thereof. Of these, plastic base materials are preferred in terms of processability.

### EXAMPLES

The present disclosure will be described below by way of Examples. The present disclosure should not be construed as being limited to these Examples.

The 50% cumulative volume-based particle diameter (D50) of the yellow pigment in the pigment dispersion composition, the distribution width of the particle size distribution, and the amine value of the dispersant polymer were obtained in the manners described below.

### <50% Cumulative Volume-Based Particle Diameter (D50) and Distribution Width of Particle Size Distribution>

The 50% cumulative volume-based particle diameter (D50) was measured with a particle size distribution analyzer (product name: UPA150, obtained from Nikkiso Co., Ltd.) with dilution of an obtained pigment dispersion composition about 500-fold with the polymerizable compound used as a dispersion medium.

The distribution width of the particle size distribution was calculated according to Mathematical formula (5) below with measurement of the 84% cumulative volume-based particle diameter (D84) and the 16% cumulative volume-based particle diameter (D16) in the same manner as the 50/cumulative volume-based particle diameter (D50).

Distribution width of particle size distribution=(84% cumulative volume-based particle diameter-16% cumulative volume-based particle diameter)/2 Mathematical formula (5)

### <Amine Value of Dispersant Polymer>

To obtain the amine value, the pigment dispersant (1 g) was dissolved in methyl isobutyl ketone (100 mL), and potentiometrically titrated with a 0.01 mol/L methyl isobutyl ketone chlorate solution, to measure a potential difference. The amine value was calculated based on the obtained potential difference. A potentiometric titrator (instrument name: GT-200, obtained from Mitsubishi Chemical Analytech Co., Ltd.) was used for the potentiometric titration.

### Example 1-1

### <Production of Pigment Dispersion Composition>

SOLSPERSE 24000 (obtained from Nippon Lubrizol Corporation, with an amine value of 41.6 mgKOH/g)(6.0 parts by mass) serving as a pigment dispersant, and acryloylmorpholine (product name: ACMO, obtained from Kohjin Film & Chemicals Co., Ltd., with a SP value of 11.55)(79.0 parts by mass) serving as a polymerizable compound were stirred and dissolved at 25 degrees C. for 4 hours, to produce a dispersion liquid.

Zirconia balls having a diameter of 2 mm (80 parts by mass), C.I. pigment yellow 138 (product name: D1080J, obtained from Clariant Japan K.K.)(3.75 parts by mass), and the dispersion liquid (21.25 parts by mass) were filled in a 50 mL mayonnaise bottle (product name: UM SAMPLE BOTTLE, obtained from As One Corporation), and subjected to dispersion treatment for 3 days using a ball mill having the conditions described below, to produce a pigment dispersion composition 1 (with a pigment content of 15% by mass). The 50% cumulative volume-based particle diameter (D50) of the obtained pigment dispersion composition 1 was 192 nm, and the distribution width of the particle size distribution was 58 nm.

### —Conditions of Ball Mill—

Media: YTZ balls with a diameter of 2 mm

(zirconia balls, obtained from Nikkato Corporation)

Mill: MIX-ROTAR VMR-5 (obtained from As One Corporation)

Number of rotation: number of rotation of mayonnaise bottle: 75 rpm

### Examples 1-2 to 1-50 and Comparative Examples 1-1 to 1-17

Pigment dispersion compositions 2 to 67 were obtained in the same manner as in Example 1-1, except that the combination of the yellow pigment, the pigment dispersant, and the polymerizable compound in the preparation of the pigment dispersion composition in Example 1-1 was changed to as presented in Tables 1 to 7 below.

Storage stability of the obtained pigment dispersion compositions 1 to 67 of Examples 1-1 to 1-50 and Comparative Examples 1-1 to 1-17 was evaluated in the manner described below. The evaluation results are presented in Tables 1 to 7 below. Because Comparative Examples 1-14 and 1-17 did not use a pigment dispersant, the pigment failed to disperse in the polymerizable compound, making it impossible to measure the viscosity change ratio and evaluate storage stability. Because Comparative Example 1-15 did not use a polymerizable compound, the amount of liquid components in the pigment dispersion composition was small, making it impossible to measure the viscosity change ratio and evaluate storage stability.

### (Storage Stability)

The initial viscosity of each of the obtained pigment dispersion compositions 1 to 67 was measured immediately after production, with a cone plate rotary viscometer (instrument name: VISCOMETER TV-22, manufactured by TOKI SANGYO CO., LTD.) with a setting of the temperature of hemathermal circulating water at 25 degrees C. at a number of rotation of 50 rpm at a shear velocity of 191.4 sec. Next, the pigment dispersion composition was left to stand still at 70 degrees C. for 14 days. Subsequently, the viscosity after storage was measured under the same conditions as the measurement of the initial viscosity. The viscosity change ratio was calculated according to Mathematical formula (6) below. Based on the viscosity change ratio, storage stability was evaluated according to the evaluation criteria described below. A lower viscosity change ratio represents a better storage stability.

Viscosity change ratio (%)=((viscosity after storage at 70 degrees C. for 14 days-initial viscosity)/initial viscosity)×100 Mathematical formula (6)

### —Evaluation Criteria—

A: The viscosity change ratio was 5% or lower.

B: The viscosity change ratio was higher than 5% but 15% or lower.

C: The viscosity change ratio was higher than 15% but 30% or lower.

D: The viscosity change ratio was higher than 30%.

TABLE 1

| | Pigment | Yellow pigment | | Pigment dispersant | | | |
|---|---|---|---|---|---|---|---|
| | dispersion | Color | Content (A) | | Amine value | Content (B) | |
| Ex. | composition No. | index | (% by mass) | Product name | (mgKOH/g) | (% by mass) | B/A |
| 1-1 | 1 | C.I. pigment | 15 | SOLSPERSE | 41.6 | 6 | 0.4 |
| | | yellow 138 | | 24000 | | | |
| 1-2 | 2 | C.I. pigment | 15 | SOLSPERSE | 31.2 | 6 | 0.4 |
| | | yellow 138 | | 32000 | | | |
| 1-3 | 3 | C.I. pigment | 15 | SOLSPERSE | 43.0 | 6 | 0.4 |
| | | yellow 138 | | 33000 | | | |
| 1-4 | 4 | C.I. pigment | 15 | SOLSPERSE | 39.0 | 6 | 0.4 |
| | | yellow 138 | | 56000 | | | |
| 1-5 | 5 | C.I. pigment | 15 | SOLSPERSE | 75.0 | 6 | 0.4 |
| | | yellow 138 | | 71000 | | | |
| 1-6 | 6 | C.I. pigment | 15 | SOLSPERSE | 80.0 | 6 | 0.4 |
| | | yellow 138 | | 73000 | | | |
| 1-7 | 7 | C.I. pigment | 15 | SOLSPERSE | 81.0 | 6 | 0.4 |
| | | yellow 138 | | 74000 | | | |
| 1-8 | 8 | C.I. pigment | 15 | SOLSPERSE | 33.0 | 6 | 0.4 |
| | | yellow 138 | | 88000 | | | |
| 1-9 | 9 | C.I. pigment | 15 | DISPERBYK- | 45.1 | 6 | 0.4 |
| | | yellow 138 | | 2055 | | | |
| 1-10 | 10 | C.I. pigment | 15 | DISPERBYK- | 52.5 | 6 | 0.4 |
| | | yellow 138 | | 2155 | | | |

| | | | | Storage stability | |
|---|---|---|---|---|---|
| | Polymerizable compound | | | Viscosity | |
| | | | Content | change ratio | |
| Ex. | Compound name | SP value | (% by mass) | (%) | Evaluation |
| 1-1 | Acryloyl morpholine | 11.55 | 79 | 1 | A |
| 1-2 | Acryloyl morpholine | 11.55 | 79 | −2 | A |
| 1-3 | Acryloyl morpholine | 11.55 | 79 | 3 | A |
| 1-4 | Acryloyl morpholine | 11.55 | 79 | 2 | A |
| 1-5 | Acryloyl morpholine | 11.55 | 79 | 1 | A |
| 1-6 | Acryloyl morpholine | 11.55 | 79 | 4 | A |
| 1-7 | Acryloyl morpholine | 11.55 | 79 | 2 | A |
| 1-8 | Acryloyl morpholine | 11.55 | 79 | −2 | A |
| 1-9 | Acryloyl morpholine | 11.55 | 79 | −4 | A |
| 1-10 | Acryloyl morpholine | 11.55 | 79 | −1 | A |

TABLE 2

| | Pigment | Yellow pigment | | Pigment dispersant | | | |
|---|---|---|---|---|---|---|---|
| | dispersion | Color | Content (A) | | Amine value | Content (B) | |
| Ex. | composition No. | index | (% by mass) | Product name | (mgKOH/g) | (% by mass) | B/A |
| 1-11 | 11 | C.I. pigment | 15 | SOLSPERSE | 75.0 | 6 | 0.4 |
| | | yellow 138 | | 71000 | | | |
| 1-12 | 12 | C.I. pigment | 15 | SOLSPERSE | 80.0 | 6 | 0.4 |
| | | yellow 138 | | 73000 | | | |
| 1-13 | 13 | C.I. pigment | 15 | SOLSPERSE | 81.0 | 6 | 0.4 |
| | | yellow 138 | | 74000 | | | |
| 1-14 | 14 | C.I. pigment | 15 | SOLSPERSE | 33.0 | 6 | 0.4 |
| | | yellow 138 | | 88000 | | | |
| 1-15 | 15 | C.I. pigment | 15 | SOLSPERSE | 80.0 | 6 | 0.4 |
| | | yellow 138 | | 73000 | | | |
| 1-16 | 16 | C.I. pigment | 15 | SOLSPERSE | 81.0 | 6 | 0.4 |
| | | yellow 138 | | 74000 | | | |
| 1-17 | 17 | C.I. pigment | 15 | SOLSPERSE | 80.0 | 6 | 0.4 |
| | | yellow 138 | | 73000 | | | |
| 1-18 | 18 | C.I. pigment | 15 | SOLSPERSE | 81.0 | 6 | 0.4 |
| | | yellow 138 | | 74000 | | | |
| 1-19 | 19 | C.I. pigment | 15 | SOLSPERSE | 81.0 | 6 | 0.4 |
| | | yellow 138 | | 74000 | | | |
| 1-20 | 20 | C.I. pigment | 15 | SOLSPERSE | 81.0 | 6 | 0.4 |
| | | yellow 138 | | 74000 | | | |

| | | | | Storage stability | |
|---|---|---|---|---|---|
| | Polymerizable compound | | | Viscosity | |
| | | | Content | change ratio | |
| Ex. | Compound name | SP value | (% by mass) | (%) | Evaluation |
| 1-11 | Tetrahydro furfuryl | 11.58 | 79 | 6 | B |
| | alcohol acrylic acid | | | | |
| | multimer ester | | | | |
| 1-12 | Tetrahydro furfuryl | 11.58 | 79 | 5 | A |
| | alcohol acrylic acid | | | | |
| | multimer ester | | | | |
| 1-13 | Tetrahydro furfuryl | 11.58 | 79 | 8 | B |
| | alcohol acrylic acid | | | | |
| | multimer ester | | | | |
| 1-14 | Tetrahydro furfuryl | 11.58 | 79 | 10 | B |
| | alcohol acrylic acid | | | | |
| | multimer ester | | | | |
| 1-15 | Methoxytetra | 10.15 | 79 | 4 | A |
| | ethylene glycol acrylate | | | | |
| | (EO-modified type) | | | | |
| 1-16 | Methoxytetra | 10.15 | 79 | 5 | A |
| | ethylene glycol acrylate | | | | |
| | (EO-modified type) | | | | |
| 1-17 | 4-Hydroxybutyl | 11.31 | 79 | 2 | A |
| | acrylate | | | | |
| 1-18 | 4-Hydroxybutyl | 11.31 | 79 | 6 | B |
| | acrylate | | | | |
| 1-19 | Dicyclopentenyloxyethyl | 10.44 | 79 | 7 | B |
| | acrylate | | | | |
| 1-20 | Dicyclopentenyloxy | 10.35 | 79 | 9 | B |
| | acrylate | | | | |

TABLE 3

| | Pigment | Yellow pigment | | Pigment dispersant | | | |
|---|---|---|---|---|---|---|---|
| | dispersion | Color | Content (A) | | Amine value | Content (B) | |
| Ex. | composition No. | index | (% by mass) | Product name | (mgKOH/g) | (% by mass) | B/A |
| 1-21 | 21 | C.I. pigment | 15 | SOLSPERSE | 35.9 | 6 | 0.4 |
| | | yellow 155 | | 20000 | | | |
| 1-22 | 22 | C.I. pigment | 15 | SOLSPERSE | 41.6 | 6 | 0.4 |
| | | yellow 155 | | 24000 | | | |
| 1-23 | 23 | C.I. pigment | 15 | SOLSPERSE | 81.0 | 2 | 0.13 |
| | | yellow 155 | | 74000 | | | |
| 1-24 | 24 | C.I. pigment | 12 | SOLSPERSE | 81.0 | 6 | 0.5 |
| | | yellow 155 | | 74000 | | | |
| 1-25 | 25 | C.I. pigment | 15 | SOLSPERSE | 81.0 | 7.5 | 0.5 |
| | | yellow 155 | | 74000 | | | |
| 1-26 | 26 | C.I. pigment | 15 | SOLSPERSE | 81.0 | 10 | 0.67 |
| | | yellow 155 | | 74000 | | | |
| 1-27 | 27 | C.I. pigment | 15 | SOLSPERSE | 81.0 | 12 | 0.8 |
| | | yellow 155 | | 74000 | | | |
| 1-28 | 28 | C.I. pigment | 15 | SOLSPERSE | 33.0 | 6 | 0.4 |
| | | yellow 155 | | 88000 | | | |
| 1-29 | 29 | C.I. pigment | 15 | DISPERBYK- | 45.1 | 6 | 0.4 |
| | | yellow 155 | | 2055 | | | |
| 1-30 | 30 | C.I. pigment | 15 | DISPERBYK- | 52.5 | 6 | 0.4 |
| | | yellow 155 | | 2155 | | | |

| | | | | Storage stability | |
|---|---|---|---|---|---|
| | Polymerizable compound | | | Viscosity | |
| | | | Content | change ratio | |
| Ex. | Compound name | SP value | (% by mass) | (%) | Evaluation |
| 1-21 | Acryloyl morpholine | 11.55 | 79 | 5 | A |
| 1-22 | Acryloyl morpholine | 11.55 | 79 | 6 | B |
| 1-23 | Acryloyl morpholine | 11.55 | 83 | 7 | B |
| 1-24 | Acryloyl morpholine | 11.55 | 82 | 5 | A |
| 1-25 | Acryloyl morpholine | 11.55 | 77.5 | 7 | B |
| 1-26 | Acryloyl morpholine | 11.55 | 75 | 8 | B |
| 1-27 | Acryloyl morpholine | 11.55 | 73 | 4 | A |
| 1-28 | Acryloyl morpholine | 11.55 | 79 | 9 | B |
| 1-29 | Acryloyl morpholine | 11.55 | 79 | 9 | B |
| 1-30 | Acryloyl morpholine | 11.55 | 79 | 8 | B |

TABLE 4

| | Pigment | Yellow pigment | | Pigment dispersant | | | |
|---|---|---|---|---|---|---|---|
| | dispersion | Color | Content (A) | | Amine value | Content (B) | |
| Ex. | composition No. | index | (% by mass) | Product name | (mgKOH/g) | (% by mass) | B/A |
| 1-31 | 31 | C.I. pigment | 15 | SOLSPERSE | 75.0 | 6 | 0.4 |
| | | yellow 155 | | 71000 | | | |
| 1-32 | 32 | C.I. pigment | 15 | SOLSPERSE | 80.0 | 6 | 0.4 |
| | | yellow 155 | | 73000 | | | |
| 1-33 | 33 | C.I. pigment | 15 | SOLSPERSE | 81.0 | 6 | 0.4 |
| | | yellow 155 | | 74000 | | | |
| 1-34 | 34 | C.I. pigment | 15 | SOLSPERSE | 33.0 | 6 | 0.4 |
| | | yellow 155 | | 88000 | | | |
| 1-35 | 35 | C.I. pigment | 15 | SOLSPERSE | 80.0 | 6 | 0.4 |
| | | yellow 155 | | 73000 | | | |
| 1-36 | 36 | C.I. pigment | 15 | SOLSPERSE | 81.0 | 6 | 0.4 |
| | | yellow 155 | | 74000 | | | |
| 1-37 | 37 | C.I. pigment | 15 | SOLSPERSE | 80.0 | 6 | 0.4 |
| | | yellow 155 | | 73000 | | | |
| 1-38 | 38 | C.I. pigment | 15 | SOLSPERSE | 81.0 | 6 | 0.4 |
| | | yellow 155 | | 74000 | | | |
| 1-39 | 39 | C.I. pigment | 15 | SOLSPERSE | 81.0 | 6 | 0.4 |
| | | yellow 155 | | 74000 | | | |
| 1-40 | 40 | C.I. pigment | 15 | SOLSPERSE | 81.0 | 6 | 0.4 |
| | | yellow 155 | | 74000 | | | |

| | | | | Storage stability | |
|---|---|---|---|---|---|
| | Polymerizable compound | | | Viscosity | |
| | | | Content | change ratio | |
| Ex. | Compound name | SP value | (% by mass) | (%) | Evaluation |
| 1-31 | Tetrahydro furfuryl | 11.58 | 79 | 9 | B |
| | alcohol acrylic acid | | | | |
| | multimer ester | | | | |
| 1-32 | Tetrahydro furfuryl | 11.58 | 79 | 10 | B |
| | alcohol acrylic acid | | | | |
| | multimer ester | | | | |
| 1-33 | Tetrahydro furfuryl | 11.58 | 79 | 10 | B |
| | alcohol acrylic acid | | | | |
| | multimer ester | | | | |
| 1-34 | Tetrahydro furfuryl | 11.58 | 79 | 10 | B |
| | alcohol acrylic acid | | | | |
| | multimer ester | | | | |
| 1-35 | Methoxytetra | 10.15 | 79 | 9 | B |
| | ethylene glycol acrylate | | | | |
| | (EO-modified type) | | | | |
| 1-36 | Methoxytetra | 10.15 | 79 | 7 | B |
| | ethylene glycol acrylate | | | | |
| | (EO-modified type) | | | | |
| 1-37 | 4-Hydroxybutyl | 11.31 | 79 | 8 | B |
| | acrylate | | | | |
| 1-38 | 4-Hydroxybutyl | 11.31 | 79 | 6 | B |
| | acrylate | | | | |
| 1-39 | Dicyclopentanyloxyethyl | 10.44 | 79 | 7 | B |
| | acrylate | | | | |
| 1-40 | Dicyclopentanyloxy | 10.35 | 79 | 9 | B |
| | acrylate | | | | |

TABLE 5

| | Pigment | Yellow pigment | | Pigment dispersant | | | |
|---|---|---|---|---|---|---|---|
| | dispersion | Color | Content (A) | | Amine value | Content (B) | |
| Ex. | composition No. | index | (% by mass) | Product name | (mgKOH/g) | (% by mass) | B/A |
| 1-41 | 41 | C.I. pigment | 15 | SOLSPERSE | 75.0 | 6 | 0.4 |
| | | yellow 180 | | 71000 | | | |
| 1-42 | 42 | C.I. pigment | 15 | SOLSPERSE | 80.0 | 6 | 0.4 |
| | | yellow 180 | | 73000 | | | |
| 1-43 | 43 | C.I. pigment | 15 | SOLSPERSE | 81.0 | 6 | 0.4 |
| | | yellow 180 | | 74000 | | | |
| 1-44 | 44 | C.I. pigment | 15 | SOLSPERSE | 81.0 | 6 | 0.4 |
| | | yellow 180 | | 74000 | | | |
| 1-45 | 45 | C.I. pigment | 15 | SOLSPERSE | 81.0 | 6 | 0.4 |
| | | yellow 180 | | 74000 | | | |
| 1-46 | 46 | C.I. pigment | 15 | SOLSPERSE | 75.0 | 6 | 0.4 |
| | | yellow 74 | | 71000 | | | |
| 1-47 | 47 | C.I. pigment | 15 | SOLSPERSE | 80.0 | 6 | 0.4 |
| | | yellow 74 | | 73000 | | | |
| 1-48 | 48 | C.I. pigment | 15 | SOLSPERSE | 81.0 | 6 | 0.4 |
| | | yellow 74 | | 74000 | | | |
| 1-49 | 49 | C.I. pigment | 15 | SOLSPERSE | 81.0 | 6 | 0.4 |
| | | yellow 74 | | 74000 | | | |
| 1-50 | 50 | C.I. pigment | 15 | SOLSPERSE | 81.0 | 6 | 0.4 |
| | | yellow 74 | | 74000 | | | |

| | | | | Storage stability | |
|---|---|---|---|---|---|
| | Polymerizable compound | | | Viscosity | |
| | | | Content | change ratio | |
| Ex. | Compound name | SP value | (% by mass) | (%) | Evaluation |
| 1-41 | Acryloyl morpholine | 11.55 | 79 | 15 | B |
| 1-42 | Acryloyl morpholine | 11.55 | 79 | 14 | B |
| 1-43 | Acryloyl morpholine | 11.55 | 79 | 10 | B |
| 1-44 | Tetrahydrofurfuryl | 11.58 | 79 | 9 | B |
| | alcohol acrylic acid | | | | |
| | multimer ester | | | | |
| 1-45 | Methoxytetra | 10.15 | 79 | 11 | B |
| | ethylene glycol acrylate | | | | |
| | (EO-modified type) | | | | |
| 1-46 | Acryloyl morpholine | 11.55 | 79 | 11 | B |
| 1-47 | Acryloyl morpholine | 11.55 | 79 | 15 | B |
| 1-48 | Acryloyl morpholine | 11.55 | 79 | 10 | B |
| 1-49 | Tetrahydrofurfuryl | 11.58 | 79 | 8 | B |
| | alcohol acrylic acid | | | | |
| | multimer ester | | | | |
| 1-50 | Methoxytetra | 10.15 | 79 | 9 | B |
| | ethylene glycol acrylate | | | | |
| | (EO-modified type) | | | | |

TABLE 6

| | Pigment | Yellow pigment | | Pigment dispersant | | | |
|---|---|---|---|---|---|---|---|
| Comp. | dispersion | Color | Content (A) | | Amine value | Content (B) | |
| Ex. | composition No. | index | (% by mass) | Product name | (mgKOH/g) | (% by mass) | B/A |
| 1-1 | 51 | C.I. pigment | 15 | AJISPER | 10.0 | 6 | 0.4 |
| | | yellow 138 | | PB-821 | | | |
| 1-2 | 52 | C.I. pigment | 15 | AJISPER | 17.0 | 6 | 0.4 |
| | | yellow 138 | | PB-822 | | | |
| 1-3 | 53 | C.I. pigment | 15 | SOLSPERSE | 81.0 | 15 | 1 |
| | | yellow 138 | | 74000 | | | |
| 1-4 | 54 | C.I. pigment | 15 | AJISPER | 10.0 | 6 | 0.4 |
| | | yellow 155 | | PB-821 | | | |
| 1-5 | 55 | C.I. pigment | 15 | BΥKJET- | 17.2 | 6 | 0.4 |
| | | yellow 155 | | 9151 | | | |
| 1-6 | 56 | C.I. pigment | 15 | SOLSPERSE | 81.0 | 1 | 0.07 |
| | | yellow 155 | | 74000 | | | |
| 1-7 | 57 | C.I. pigment | 15 | AJISPER | 10.0 | 6 | 0.4 |
| | | yellow 180 | | PB-821 | | | |
| 1-8 | 58 | C.I. pigment | 15 | BYKJET- | 27.3 | 6 | 0.4 |
| | | yellow 180 | | 9152 | | | |
| 1-9 | 59 | C.I. pigment | 15 | AJISPER | 10.0 | 6 | 0.4 |
| | | yellow 74 | | PB-821 | | | |
| 1-10 | 60 | C.I. pigment | 15 | BYKJET- | 27.3 | 6 | 0.4 |
| | | yellow 74 | | 9152 | | | |

| | | | | Storage stability | |
|---|---|---|---|---|---|
| | Polymerizable compound | | | Viscosity | |
| Comp. | | | Content | change ratio | |
| Ex. | Compound name | SP value | (% by mass) | (%) | Evaluation |
| 1-1 | Acryloyl morpholine | 11.55 | 79 | 653 | D |
| 1-2 | Tetrahydrofurfuryl | 11.58 | 79 | 897 | D |
| | alcohol acrylic acid | | | | |
| | multimer ester | | | | |
| 1-3 | Acryloyl morpholine | 11.55 | 70 | 176 | D |
| 1-4 | Acryloyl morpholine | 11.55 | 79 | 455 | D |
| 1-5 | Tetrahydrofurfuryl | 11.58 | 79 | 104 | D |
| | alcohol acrylic acid | | | | |
| | multimer ester | | | | |
| 1-6 | Acryloyl morpholine | 11.55 | 84 | 56 | D |
| 1-7 | Acryloyl morpholine | 11.55 | 79 | 290 | D |
| 1-8 | Acryloyl morpholine | 11.55 | 79 | 121 | D |
| 1-9 | Acryloyl morpholine | 11.55 | 79 | 240 | D |
| 1-10 | Acryloyl morpholine | 11.55 | 79 | 255 | D |

TABLE 7

| | Pigment | Yellow pigment | | Pigment dispersant | | | |
|---|---|---|---|---|---|---|---|
| Comp. | dispersion | Color | Content (A) | | Amine value | Content (B) | |
| Ex. | composition No. | index | (% by mass) | Product name | (mgKOH/g) | (% by mass) | B/A |
| 1-11 | 61 | C.I. pigment | 15 | SOLSPERSE | 81.0 | 4.5 | 0.3 |
| | | yellow 155 | | 74000 | | | |
| 1-12 | 62 | C.I. pigment | 15 | SOLSPERSE | 81.0 | 6 | 0.4 |
| | | yellow 155 | | 74000 | | | |
| 1-13 | 63 | C.I. pigment | 15 | BYK- | 140.0 | 6 | 0.4 |
| | | yellow 155 | | 109 | | | |
| 1-14 | 64 | C.I. pigment | 15 | — | — | — | — |
| | | yellow 155 | | | | | |
| 1-15 | 65 | C.I. pigment | 71.4 | SOLSPERSE | 81.0 | 28.6 | 0.4 |
| | | yellow 155 | | 74000 | | | |
| 1-16 | 66 | C.I. pigment | 15 | BYK- | 140.0 | 3 | 0.2 |
| | | yellow 155 | | 109 | | | |
| 1-17 | 67 | C.I. pigment | 15 | — | — | — | — |
| | | yellow 155 | | | | | |

| | | | | Storage stability | |
|---|---|---|---|---|---|
| | Polymerizable compound | | | Viscosity | |
| Comp. | | | Content | change ratio | |
| Ex. | Compound name | SP value | (% by mass) | (%) | Evaluation |
| 1-11 | Phenoxyethyl acrylate | 9.99 | 80.5 | 104 | D |
| 1-12 | Phenoxyethyl acrylate | 9.99 | 79 | 156 | D |
| 1-13 | Phenoxyethyl acrylate | 9.99 | 70 | 294 | D |
| 1-14 | Phenoxyethyl acrylate | 9.99 | 85 | — | — |
| 1-15 | — | — | — | — | — |
| 1-16 | Acryloyl morpholine | 11.55 | 82 | 899 | D |
| 1-17 | Acryloyl morpholine | 11.55 | 85 | — | — |

The suppliers and product names of the components in Tables 1 to 7 above are as described below,

### —Yellow Pigment—

D1080J: C.I. pigment yellow 138, obtained from BASF Japan Ltd.
4GC: C.I. pigment yellow 155, obtained from Clariant Japan K.K.
P-HG: C.I. pigment yellow 180, obtained from Clariant Japan K.K.
Fast yellow 531: C.I. pigment yellow 74, obtained from Dainichiseika Color & Chemicals Mfg. Co., Ltd.

### —Dispersant Polymer—

SOLSPERSE 24000 (obtained from Nippon Lubrizol Corporation, with an amine value of 41.6 mgKOH/g)
SOLSPERSE 32000 (obtained from Nippon Lubrizol Corporation, with an amine value of 31.2 mgKOH/g)
SOLSPERSE 33000 (obtained from Nippon Lubrizol Corporation, with an amine value of 43.0 mgKOH/g)
SOLSPERSE 56000 (obtained from Nippon Lubrizol Corporation, with an amine value of 39.0 mgKOH/g)
SOLSPERSE 71000 (obtained from Nippon Lubrizol Corporation, with an amine value of 75.0 mgKOH/g)
SOLSPERSE 73000 (obtained from Nippon Lubrizol Corporation, with an amine value of 80.0 mgKOH/g)
SOLSPERSE 74000 (obtained from Nippon Lubrizol Corporation, with an amine value of 81.0 mgKOH/g)
SOLSPERSE 88000 (obtained from Nippon Lubrizol Corporation, with an amine value of 33.0 mgKOH/g)
DISPERBYK-2055 (obtained from Byk-Chemie Japan K.K., with an amine value of 45.1 mgKOH/g)
DISPERBYK-2155 (obtained from Byk-Chemie Japan K.K., with an amine value of 52.5 mgKOH/g)
AJISPER PB-821 (obtained from Ajinomoto Fine-Techno Co., Inc., with an amine value of 10.0 mgKOH/g)
AJISPER PB-822 (obtained from Ajinomoto Fine-Techno Co., Inc., with an amine value of 17.0 mgKOH/g)
BYKJET-9151 (obtained from Byk-Chemie Japan K.K., with an amine value of 17.2 mgKOH/g)
BYKJET-9152 (obtained from Byk-Chemie Japan K.K., with an amine value of 27.3 mgKOH/g)

DISPERBYK-109 (obtained from Byk-Chemie Japan K.K., with an amine value of 140 mgKOH/g)

### —Polymerizable Compound—

Acryloylmorpholine (product name: ACMO, obtained from KJ Chemicals Corporation, with a SP value of 11.55)
A compound represented by structural formula (1) below (product name: V #150D, obtained from Osaka Organic Chemical Industry Ltd., with a SP value of 11.58)

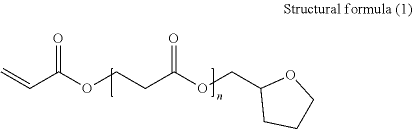

where n represents an integer of 1 or greater,
Methoxytetraethylene glycol acrylate (EO-modified)(product name: ME-4S, obtained from DKS Co., Ltd., with a SP value of 10.15)
4-Hydroxybutyl acrylate (product name of HBA, obtained from Mitsubishi Chemical Corporation, with a SP value of 11.31)
Dicyclopentenyloxyethyl acrylate (product name: FA-512AS, obtained from Hitachi Chemical Corporation, with a SP value of 10.44)
Dicyclopentanyloxyethyl acrylate (product name: FA-513AS, obtained from Hitachi Chemical Corporation, with a SP value of 10.35)
Phenoxyethyl acrylate (product name: VISCOAT #192, obtained from Osaka Organic Chemical Industry Ltd., with a SP value of 9.99)

### Example 2-1

### <Production of Curable Composition>

The pigment dispersion composition 1 obtained in Example 1-1 (20.0 parts by mass), phenoxyethyl acrylate (20.0 parts by mass), acryloylmorpholine (20.0 parts by mass), isobornyl acrylate (10.0 parts by mass), tetrahydrofurfuryl acrylate (5.0 parts by mass), 1,9-nonanediol diacrylate (5.0 parts by mass), trimethylolpropane triacrylate (5.0 parts by mass), tricyclodecane dimethanol diacrylate (2.0 parts by mass), ϑ-caprolactone-modified dipentaerythritol acrylate (2.0 parts by mass), aliphatic urethane acrylate (IBOA blend)(0.5 parts by mass), a surfactant B (0.3 parts by mass), a polymerization initiator A (5.0 parts by mass), a polymerization initiator B (3.0 parts by mass), a polymerization initiator C (2.0 parts by mass), and 4-methoxyphenol (0.2 parts by mass) were mixed, to obtain a curable composition 1.

### Examples 2-1 to 2-40 and Comparative Examples 2-1 to 2-17

Curable compositions 2 to 57 were obtained in the same manner as in Example 2-1, except that the combination of the compositions in Example 2-1 was changed to as presented in Table 8 to Table 13 below.

TABLE 8

| | | | Ex. | | | | | | | | | |
|---|---|---|---|---|---|---|---|---|---|---|---|---|
| | | | 2-1 | 2-2 | 2-3 | 2-4 | 2-5 | 2-6 | 2-7 | 2-8 | 2-9 | 2-10 |
| Curable composition No. | | | 1 | 2 | 3 | 4 | 5 | 6 | 7 | 8 | 9 | 10 |
| Pigment dispersion | | No. | 1 | 2 | 3 | 4 | 5 | 6 | 7 | 8 | 9 | 10 |
| composition | | Content (% by mass) | 20.0 | 20.5 | 20.5 | 20.5 | 20.5 | 20.5 | 20.5 | 20.5 | 20.5 | 20.5 |
| Polymerizable | Monofunctional | Phenoxyethyl acrylate | 20 | 10 | 20 | | 20 | | 20 | | 20 | 15 |
| compound | compound | Acryloylmorpholine | 20 | 20 | 20 | 20 | 20 | 20 | 20 | 30 | 20 | 15 |
| | | Isobornyl acrylate | 10 | 10 | 10 | 20 | 10 | 10 | 10 | 10 | 10 | 5 |
| | | Benzyl acrylate | | 10 | | 5 | | | | 20 | | |
| | | Tetrahydrofurfuryl acrylate | 5 | 5 | 5 | | 5 | 20 | 5 | | 3 | 5 |
| | | 4-Hydroxybutyl acrylate | | 5 | | 4 | | 4 | | | | |
| | | Methoxytetraethylene | | | | 5 | | 2 | | 3 | | 5 |
| | | glycol acrylate (EO-modified) | | | | | | | | | | |
| | | Tetrahydrofurfuryl alcohol | | | | 5 | | 5 | | | | 5 |
| | | acrylic acid multimer ester | | | | | | | | | | |
| | | Dicyclopentenyloxyethyl | | | | | | 5 | | 3 | | |
| | | acrylate | | | | | | | | | | |
| | Multifunctional | 1,9-Nonanediol diacrylate | 5 | | 5 | | | | 5 | | 3 | 4 |
| | compound | Trimethylolpropane triacrylate | 5 | 5 | 5 | | 2 | 2 | 5 | | 3 | 5 |
| | | Tricyclodecane dimethanol | 2 | 2 | 2 | 2 | 2 | | | | 2 | 2 |
| | | diacrylate | | | | | | | | | | |
| | | ε-caprolactone-modified | 2 | 2 | | | 2 | 2 | 2 | | 2 | 2 |
| | | dipentaerythritol acrylate | | | | | | | | | | |

| | | | | | | | | | | | |
|---|---|---|---|---|---|---|---|---|---|---|---|
| Oligomer | Urethane acrylate | | | | | 2 | | 2 | | | |
| | Aliphatic urethane acrylate | 0.5 | | 2 | 2 | 2 | | | 2 | 2 | 2 |
| | (IBOA blend) | | | | | | | | | | |
| Surfactant | Surfactant A | | | | | | 0.3 | 0.3 | 0.3 | 0.3 | 0.3 |
| | Surfactant B | 0.3 | 0.3 | 0.3 | 0.3 | 0.3 | | | | | |
| Polymerization | Polymerization initiator A | 5 | 5 | 5 | | | 7 | 8 | 9 | | |
| initiator | Polymerization initiator B | 3 | 3 | 3 | | | | | | | |
| | 4-Benzoyl-4′- | | | | 7 | 7 | | | | | |
| | methyldiphenyl sulfide | | | | | | | | | | |
| | 4-Phenyl benzophenone | | | | | | | | | 7 | 7 |
| | Polymerization initiator C | 2 | 2 | 2 | | | 2 | 2 | 2 | | |
| Hydrogen donor | Ethyl 4-dimethylamino | | | | 7 | 7 | | | | 7 | 7 |
| | benzoate | | | | | | | | | | |
| Polymerization inhibitor | 4-Methoxypherol | 0.2 | 0.2 | 0.2 | 0.2 | 0.2 | 0.2 | 0.2 | 0.2 | 0.2 | 0.2 |

| | | | | | | | | | | |
|---|---|---|---|---|---|---|---|---|---|---|
| Total (% by mass) | 100 | 100 | 100 | 100 | 100 | 100 | 100 | 100 | 100 | 100 |

TABLE 9

| | | | Ex. | | | | | | | | | |
|---|---|---|---|---|---|---|---|---|---|---|---|---|
| | | | 2-11 | 2-12 | 2-13 | 2-14 | 2-15 | 2-16 | 2-17 | 2-18 | 2-19 | 2-20 |
| Curable composition No. | | | 11 | 12 | 13 | 14 | 15 | 16 | 17 | 18 | 19 | 20 |
| Pigment dispersion | | No. | 11 | 12 | 13 | 14 | 15 | 16 | 17 | 18 | 19 | 20 |
| composition | | Content (% by mass) | 20.5 | 20.5 | 20.5 | 20.5 | 20.5 | 20.5 | 20.5 | 20.5 | 20.5 | 20.5 |
| Polymerizable | Monofunctional | Phenoxyethyl acrylate | 20 | 10 | 20 | | 20 | | 20 | | 20 | 15 |
| compound | compound | Acryloylmorpholine | 20 | 20 | 20 | 20 | 20 | 20 | 20 | 30 | 20 | 15 |
| | | Isobornyl acrylate | 10 | 10 | 10 | 20 | 10 | 10 | 10 | 10 | 10 | 5 |
| | | Benzyl acrylate | | 10 | | 5 | | | | 20 | | |
| | | Tetrahydrofurfuryl acrylate | 5 | 5 | 5 | | 5 | 20 | 5 | | 3 | 5 |
| | | 4-Hydroxybutyl acrylate | | 5 | | 4 | | 4 | | | | |
| | | Methoxytetraethylene | | | | 5 | | 2 | | 3 | | 5 |
| | | glycol acrylate (EO-modified) | | | | | | | | | | |
| | | Tetrahydrofurfuryl alcohol | | | | 5 | | 5 | | | | 5 |
| | | acrylic acid multimer ester | | | | | | | | | | |
| | | Dicyclopentenyloxyethyl | | | | | | 5 | | 3 | | |
| | | acrylate | | | | | | | | | | |
| | Multifunctional | 1,9-Nonanediol diacrylate | 5 | | 5 | 2 | | | 5 | | 3 | 4 |
| | compound | Trimethylolpropane triacrylate | 5 | 5 | 5 | | 2 | 2 | 5 | | 3 | 5 |
| | | Tricyclodecane dimethanol | 2 | 2 | 2 | 2 | 2 | | | | 2 | 2 |
| | | diacrylate | | | | | | | | | | |
| | | ε-caprolactone-modified | 2 | 2 | | | 2 | 2 | 2 | | 2 | 2 |
| | | dipentaerythritol acrylate | | | | | | | | | | |

| | | | | | | | | | | | |
|---|---|---|---|---|---|---|---|---|---|---|---|
| Oligomer | Urethane acrylate | | | | | 2 | | 2 | | | |
| | Aliphatic urethane acrylate | 0.5 | | 2 | 2 | 2 | | | 2 | 2 | 2 |
| | (IBOA blend) | | | | | | | | | | |
| Surfactant | Surfactant A | | | | | | 0.3 | 0.3 | 0.3 | 0.3 | 0.3 |
| | Surfactant B | 0.3 | 0.3 | 0.3 | 0.3 | 0.3 | | | | | |
| Polymerization | Polymerization initiator A | 5 | 5 | 5 | | | 7 | 8 | 9 | | |
| initiator | Polymerization initiator B | 3 | 3 | 3 | | | | | | | |
| | 4-Benzoyl-4′- | | | | 7 | 7 | | | | | |
| | methyldiphenyl sulfide | | | | | | | | | | |
| | 4-Phenyl benzophenone | | | | | | | | | 7 | 7 |
| | Polymerization initiator C | 2 | 2 | 2 | | | 2 | 2 | 2 | | |
| Hydrogen donor | Ethyl 4-dimethylamino | | | | 7 | 7 | | | | 7 | 7 |
| | benzoate | | | | | | | | | | |
| Polymerization inhibitor | 4-Methoxypherol | 0.2 | 0.2 | 0.2 | 0.2 | 0.2 | 0.2 | 0.2 | 0.2 | 0.2 | 0.2 |

| | | | | | | | | | | |
|---|---|---|---|---|---|---|---|---|---|---|
| Total (% by mass) | 100 | 100 | 100 | 100 | 100 | 100 | 100 | 100 | 100 | 100 |

TABLE 10

| | | | Ex. | | | | | | | | | |
|---|---|---|---|---|---|---|---|---|---|---|---|---|
| | | | 2-21 | 2-22 | 2-23 | 2-24 | 2-25 | 2-26 | 2-27 | 2-28 | 2-29 | 2-30 |
| Curable composition No. | | | 21 | 22 | 23 | 24 | 25 | 26 | 27 | 28 | 29 | 30 |
| Pigment dispersion | | No. | 21 | 22 | 23 | 24 | 25 | 26 | 27 | 28 | 29 | 30 |
| composition | | Content (% by mass) | 20.5 | 20.5 | 20.5 | 20.5 | 20.5 | 20.5 | 20.5 | 20.5 | 20.5 | 20.5 |
| Polymerizable | Monofunctional | Phenoxyethyl acrylate | 20 | 10 | 20 | | 20 | | 20 | | 20 | 15 |
| compound | compound | Acryloylmorpholine | 20 | 20 | 20 | 20 | 20 | 20 | 20 | 30 | 20 | 15 |
| | | Isobornyl acrylate | 10 | 10 | 10 | 20 | 10 | 10 | 10 | 10 | 10 | 5 |
| | | Benzyl acrylate | | 10 | | 5 | | | | 20 | | |
| | | Tetrahydrofurfuryl acrylate | 5 | 5 | 5 | | 5 | 20 | 5 | | 3 | 5 |
| | | 4-Hydroxybutyl acrylate | | 5 | | 4 | | 4 | | | | |
| | | Methoxytetraethylene | | | | 5 | | 2 | | 3 | | 5 |
| | | glycol acrylate (EO-modified) | | | | | | | | | | |
| | | Tetrahydrofurfuryl alcohol | | | | 5 | | 5 | | | | 5 |
| | | acrylic acid multimer ester | | | | | | | | | | |
| | | Dicyclopentenyloxyethyl | | | | | | 5 | | 3 | | |
| | | acrylate | | | | | | | | | | |
| | Multifunctional | 1,9-Nonanediol diacrylate | 5 | | 5 | 2 | | | 5 | | 3 | 4 |
| | compound | Trimethylolpropane triacrylate | 5 | 5 | 5 | | 2 | 2 | 5 | | 3 | 5 |
| | | Tricyclodecane dimethanol | 2 | 2 | 2 | 2 | 2 | | | | 2 | 2 |
| | | diacrylate | | | | | | | | | | |
| | | ε-caprolactone-modified | 2 | 2 | | | 2 | 2 | 2 | | 2 | 2 |
| | | dipentaerythritol acrylate | | | | | | | | | | |

| | | | | | | | | | | | |
|---|---|---|---|---|---|---|---|---|---|---|---|
| Oligomer | Urethane acrylate | | | | | 2 | | 2 | | | |
| | Aliphatic urethane acrylate | 0.5 | | 2 | 2 | 2 | | | 2 | 2 | 2 |
| | (IBOA blend) | | | | | | | | | | |
| Surfactant | Surfactant A | | | | | | 0.3 | 0.3 | 0.3 | 0.3 | 0.3 |
| | Surfactant B | 0.3 | 0.3 | 0.3 | 0.3 | 0.3 | | | | | |
| Polymerization | Polymerization initiator A | 5 | 5 | 5 | | | 7 | 8 | 9 | | |
| initiator | Polymerization initiator B | 3 | 3 | 3 | | | | | | | |
| | 4-Benzoyl-4′- | | | | 7 | 7 | | | | | |
| | methyldiphenyl sulfide | | | | | | | | | | |
| | 4-Phenyl benzophenone | | | | | | | | | 7 | 7 |
| | Polymerization initiator C | 2 | 2 | 2 | | | 2 | 2 | 2 | | |
| Hydrogen donor | Ethyl 4-dimethylamino | | | | 7 | 7 | | | | 7 | 7 |
| | benzoate | | | | | | | | | | |
| Polymerization inhibitor | 4-Methoxypherol | 0.2 | 0.2 | 0.2 | 0.2 | 0.2 | 0.2 | 0.2 | 0.2 | 0.2 | 0.2 |

| | | | | | | | | | | |
|---|---|---|---|---|---|---|---|---|---|---|
| Total (% by mass) | 100 | 100 | 100 | 100 | 100 | 100 | 100 | 100 | 100 | 100 |

TABLE 11

| | | | Ex. | | | | | | | | | |
|---|---|---|---|---|---|---|---|---|---|---|---|---|
| | | | 2-31 | 2-32 | 2-33 | 2-34 | 2-35 | 3-36 | 2-37 | 2-38 | 3-39 | 2-40 |
| Curable composition No. | | | 31 | 32 | 33 | 34 | 35 | 36 | 37 | 38 | 39 | 40 |
| Pigment dispersion | | No. | 31 | 32 | 33 | 34 | 35 | 36 | 37 | 38 | 39 | 40 |
| composition | | Content (% by mass) | 20.5 | 20.5 | 20.5 | 20.5 | 20.5 | 20.5 | 20.5 | 20.5 | 20.5 | 20.5 |
| Polymerizable | Monofunctional | Phenoxyethyl acrylate | 20 | 10 | 20 | | 20 | | 20 | | 20 | 15 |
| compound | compound | Acryloylmorpholine | 20 | 20 | 20 | 20 | 20 | 20 | 20 | 30 | 20 | 15 |
| | | Isobornyl acrylate | 10 | 10 | 10 | 20 | 10 | 10 | 10 | 10 | 10 | 5 |
| | | Benzyl acrylate | | 10 | | 5 | | | | 20 | | |
| | | Tetrahydrofurfuryl acrylate | 5 | 5 | 5 | | 5 | 20 | 5 | | 3 | 5 |
| | | 4-Hydroxybutyl acrylate | | 5 | | 4 | | 4 | | | | |
| | | Methoxytetraethylene | | | | 5 | | 2 | | 3 | | 5 |
| | | glycol acrylate (EO-modified) | | | | | | | | | | |
| | | Tetrahydrofurfuryl alcohol | | | | 5 | | 5 | | | | 5 |
| | | acrylic acid multimer ester | | | | | | | | | | |
| | | Dicyclopentenyloxyethyl | | | | | | 5 | | 3 | | |
| | | acrylate | | | | | | | | | | |
| | Multifunctional | 1,9-Nonanediol diacrylate | 5 | | 5 | 2 | | | 5 | | 3 | 4 |
| | compound | Trimethylolpropane triacrylate | 5 | 5 | 5 | | 2 | 2 | 5 | | 3 | 5 |
| | | Tricyclodecane dimethanol | 2 | 2 | 2 | 2 | 2 | | | | 2 | 2 |
| | | diacrylate | | | | | | | | | | |
| | | ε-caprolactone-modified | 2 | 2 | | | 2 | 2 | 2 | | 2 | 2 |
| | | dipentaerythritol acrylate | | | | | | | | | | |

| | | | | | | | | | | | |
|---|---|---|---|---|---|---|---|---|---|---|---|
| Oligomer | Urethane acrylate | | | | | 2 | | 2 | | | |
| | Aliphatic urethane acrylate | 0.5 | | 2 | 2 | 2 | | | 2 | 2 | 2 |
| | (IBOA blend) | | | | | | | | | | |
| Surfactant | Surfactant A | | | | | | 0.3 | 0.3 | 0.3 | 0.3 | 0.3 |
| | Surfactant B | 0.3 | 0.3 | 0.3 | 0.3 | 0.3 | | | | | |
| Polymerization | Polymerization initiator A | 5 | 5 | 5 | | | 7 | 8 | 9 | | |
| initiator | Polymerization initiator B | 3 | 3 | 3 | | | | | | | |
| | 4-Benzoyl-4′- | | | | 7 | 7 | | | | | |
| | methyldiphenyl sulfide | | | | | | | | | | |
| | 4-Phenyl benzophenone | | | | | | | | | 7 | 7 |
| | Polymerization initiator C | 2 | 2 | 2 | | | 2 | 2 | 2 | | |
| Hydrogen donor | Ethyl 4-dimethylamino | | | | 7 | 7 | | | | 7 | 7 |
| | benzoate | | | | | | | | | | |
| Polymerization inhibitor | 4-Methoxypherol | 0.2 | 0.2 | 0.2 | 0.2 | 0.2 | 0.2 | 0.2 | 0.2 | 0.2 | 0.2 |

| | | | | | | | | | | |
|---|---|---|---|---|---|---|---|---|---|---|
| Total (% by mass) | 100 | 100 | 100 | 100 | 100 | 100 | 100 | 100 | 100 | 100 |

TABLE 12

| | | | Comp. Ex. | | | | | | | |
|---|---|---|---|---|---|---|---|---|---|---|
| | | | 2-1 | 2-2 | 2-3 | 2-4 | 2-5 | 2-6 | 2-7 | 2-8 |
| Curable composition No. | | | 41 | 42 | 43 | 44 | 45 | 46 | 47 | 48 |
| Pigment dispersion | | No. | 51 | 52 | 53 | 54 | 55 | 56 | 57 | 58 |
| composition | | Content (% by mass) | 20.5 | 20.5 | 20.5 | 20.5 | 20.5 | 20.5 | 20.5 | 20.5 |
| Polymerizable | Monofunctional | Phenoxyethyl acrylate | 20 | 10 | 20 | | 20 | | 20 | |
| compound | compound | Acryloylmorpholine | 20 | 20 | 20 | 20 | 20 | 20 | 20 | 30 |
| | | Isobornyl acrylate | 10 | 10 | 10 | 20 | 10 | 10 | 10 | 10 |
| | | Benzyl acrylate | | 10 | | 5 | | | | 20 |
| | | Tetrahydrofurfuryl acrylate | 5 | 5 | 5 | | 5 | 20 | 5 | |
| | | 4-Hydroxybutyl acrylate | | 5 | | 4 | | 4 | | |
| | | Methoxytetraethylene | | | | 5 | | 2 | | 3 |
| | | glycol acrylate (EO-modified) | | | | | | | | |
| | | Tetrahydrofurfuryl alcohol | | | | 5 | | 5 | | |
| | | acrylic acid multimer ester | | | | | | | | |
| | | Dicyclopentenyloxyethyl | | | | | | 5 | | 3 |
| | | acrylate | | | | | | | | |
| | Multifunctional | 1,9-Nonanediol diacrylate | 5 | | 5 | 2 | | | 5 | |
| | compound | Trimethylolpropane triacrylate | 5 | 5 | 5 | | 2 | 2 | 5 | |
| | | Tricyclodecane dimethanol | 2 | 2 | 2 | 2 | 2 | | | |
| | | diacrylate | | | | | | | | |
| | | ε-caprolactone-modified | 2 | 2 | | | 2 | 2 | 2 | |
| | | dipentaerythritol acrylate | | | | | | | | |

| | | | | | | | | | |
|---|---|---|---|---|---|---|---|---|---|
| Oligomer | Urethane acrylate | | | | | 2 | | 2 | |
| | Aliphatic urethane acrylate | 0.5 | | 2 | 2 | 2 | | | 2 |
| | (IBOA blend) | | | | | | | | |
| Surfactant | Surfactant A | | | | | | 0.3 | 0.3 | 0.3 |
| | Surfactant B | 0.3 | 0.3 | 0.3 | 0.3 | 0.3 | | | |
| Polymerization | Polymerization initiator A | 5 | 5 | 5 | | | 7 | 8 | 9 |
| initiator | Polymerization initiator B | 3 | 3 | 3 | | | | | |
| | 4-Benzoyl-4′- | | | | 7 | 7 | | | |
| | methyldiphenyl sulfide | | | | | | | | |
| | 4-Phenyl benzophenone | | | | | | | | |
| | Polymerization initiator C | 2 | 2 | 2 | | | 2 | 2 | 2 |
| Hydrogen donor | Ethyl 4-dimethylamino | | | | 7 | 7 | | | |
| | benzoate | | | | | | | | |
| Polymerization inhibitor | 4-Methoxypherol | 0.2 | 0.2 | 0.2 | 0.2 | 0.2 | 0.2 | 0.2 | 0.2 |

| | | | | | | | | |
|---|---|---|---|---|---|---|---|---|
| Total (% by mass) | 100 | 100 | 100 | 100 | 100 | 100 | 100 | 100 |

TABLE 13

| | | | Comp. Ex. | | | | | | | | |
|---|---|---|---|---|---|---|---|---|---|---|---|
| | | | 2-9 | 2-10 | 2-11 | 2-12 | 2-13 | 2-14 | 2-15 | 2-16 | 2-17 |
| Curable composition No. | | | 49 | 50 | 51 | 52 | 53 | 54 | 55 | 56 | 57 |
| Pigment dispersion | | No. | 59 | 60 | 61 | 62 | 63 | 64 | 65 | 66 | 67 |
| composition | | Content (% by mass) | 20.5 | 20.5 | 20.5 | 20.5 | 20.5 | 20.5 | 20.5 | 20.5 | 20.5 |
| Polymerizable | Monofunctional | Phenoxyethyl acrylate | 20 | 15 | 15 | 15 | 15 | 15 | 15 | 15 | 15 |
| compound | compound | Acryloylmorpholine | 20 | 15 | 15 | 15 | 15 | 15 | 15 | 15 | 15 |
| | | Isobornyl acrylate | 10 | 5 | 10 | 10 | 10 | 10 | 10 | 10 | 10 |
| | | Benzyl acrylate | | | | | | | | | |
| | | Tetrahydrofurfuryl acrylate | 3 | 5 | | | | | | | |
| | | 4-Hydroxybutyl acrylate | | | | | | | | | |
| | | Methoxytetraethylene | | 5 | 5 | 5 | 5 | 5 | 5 | 5 | 5 |
| | | glycol acrylate (EO-modified) | | | | | | | | | |
| | | Tetrahydrofurfuryl alcohol | | 5 | 5 | 5 | 5 | 5 | 5 | 5 | 5 |
| | | acrylic acid multimer ester | | | | | | | | | |
| | | Dicyclopentenyloxyethyl | | | | | | | | | |
| | | acrylate | | | | | | | | | |
| | Multifunctional | 1,9-Nonanediol diacrylate | 3 | 4 | 6 | 6 | 6 | 6 | 6 | 6 | 6 |
| | compound | Trimethylolpropane triacrylate | 3 | 5 | 7 | 7 | 7 | 7 | 7 | 7 | 7 |
| | | Tricyclodecane dimethanol | 2 | 2 | | | | | | | |
| | | diacrylate | | | | | | | | | |
| | | ε-caprolactone-modified | 2 | 2 | | | | | | | |
| | | dipentaerythritol acrylate | | | | | | | | | |

| | | | | | | | | | | |
|---|---|---|---|---|---|---|---|---|---|---|
| Oligomer | Urethane acrylate | | | | | | | | | |
| | Aliphatic urethane acrylate | 2 | 2 | 2 | 2 | 2 | 2 | 2 | 2 | 2 |
| | (IBOA blend) | | | | | | | | | |
| Surfactant | Surfactant A | 0.3 | 0.3 | 0.3 | 0.3 | 0.3 | 0.3 | 0.3 | 0.3 | 0.3 |
| | Surfactant B | | | | | | | | | |
| Polymerization | Polymerization initiator A | | | 7 | 7 | 7 | 7 | 7 | 7 | 7 |
| initiator | Polymerization initiator B | | | | | | | | | |
| | 4-Benzoyl-4′- | | | | | | | | | |
| | methyldiphenyl sulfide | | | | | | | | | |
| | 4-Phenyl benzophenone | 7 | 7 | | | | | | | |
| | Polymerization initiator C | | | 7 | 7 | 7 | 7 | 7 | 7 | 7 |
| Hydrogen donor | Ethyl 4-dimethylamino | 7 | 7 | | | | | | | |
| | benzoate | | | | | | | | | |
| Polymerization inhibitor | 4-Methoxypherol | 0.2 | 0.2 | 0.2 | 0.2 | 0.2 | 0.2 | 0.2 | 0.2 | 0.2 |

| | | | | | | | | | |
|---|---|---|---|---|---|---|---|---|---|
| Total (% by mass) | 100 | 100 | 100 | 100 | 100 | 100 | 100 | 100 | 100 |

The names and suppliers of the products in Tables 8 to 13 are as follows.

### —Monofunctional Compound—

Isobornyl acrylate (product name: IBXA, obtained from Osaka Organic Chemical Industry Ltd, with aSP value of 7.24)
Benzyl acrylate (product name: VISCOAT #160, obtained from Osaka Organic Chemical Industry Ltd., with aSP value of 10.00)
Tetrahydrofurfuryl acrylate (product name: VISCOAT #150, obtained from Osaka Organic Chemical Industry Ltd., with aSP value of 9.97)

### —Multifunctional Compound—

1,9-Nonanediol diacrylate (product name: VISCOAT #260, obtained from Osaka Organic Chemical Industry Ltd., a bifunctional monomer, with a SP value of 9.08)
Trimethylolpropane triacrylate (product name: VISCOAT #295, obtained from Osaka Organic Chemical Industry Ltd., a trifunctional monomer, with a SP value of 8.54)
Tricyclodecanedimethanol diacrylate (product name: KAYARAD R-684, obtained from Nippon Kayaku Co., Ltd., a bifunctional monomer, with a SP value of 8.10)
ε-Caprolactone-modified dipentaerythritol acrylate (product name: KAYARAD DPCA-60, obtained from Nippon Kayaku Co., Ltd., a pentafunctional or higher multifunctional monomer, with a SP value of 8.85)

### —Oligomer—

Urethane acrylate resin (product name: UV-3010B, obtained from Nippon Synthetic Chemical Industry Co., Ltd., an ultraviolet-curable resin)
Aliphatic urethane acrylate (IBOA blend) (with two functional groups, product name: CN963J85, obtained from Sartomer USA, LLC)

### —Surfactant—

Surfactant A (product name: BYK-3575, obtained from Byk-Chemie Japan K.K.)
Surfactant B (product name: WET270, obtained from Evonik Industries AG)

### —Polymerization Initiator—

Polymerization initiator A (product name: DAROCURE TPO, obtained from BASF Japan Ltd.)
Polymerization initiator B (product name: IRGACURE 819, obtained from BASF Japan Ltd.)
4-Benzoyl-4′-methyldiphenyl sulfide (obtained from Tokyo Chemical Industry Co., Ltd.)
4-Phenylbenzophenone (obtained from Tokyo Chemical Industry Co., Ltd.)
Polymerization initiator C (product name: SPEEDCURE DETX, Lambson Limited)

### —Hydrogen Donor—

Ethyl 4-dimethylamino benzoate (product name: KAYACURE EPA, obtained from Nippon Kayaku Co., Ltd.)

### —Polymerization Inhibitor—

4-Methoxyphenol (obtained from Nippon Kayaku Co., Ltd.)

Liquid permeability, discharging stability, storage stability (viscosity change ratio), curability (cumulative amount of light for irradiation needed for curing), and adhesiveness of the obtained curable compositions of Examples 2-1 and 2-40 and Comparative Examples 2-1 to 2-17 were evaluated in the manners described below. The results are presented in Tables 14 to 19.

### <Liquid Permeability>

Each curable composition (100 mL) was filtrated through a hydrophobic PTFE membrane filter having an average pore diameter of 10.0 micrometers under pressurization at 50 kPa, to evaluate liquid permeability according to the evaluation criteria described below.

### —Evaluation Criteria—

A: Seventy five milliliters or more of the curable composition permeated the filter.

B: Fifty milliliters or more but less than 75 mL of the curable composition permeated the filter.

C: Twenty five milliliters or more but less than 50 mL of the curable composition permeated the filter.

D: Less than 25 mL of the curable composition permeated the filter.

### <Discharging Stability>

An inkjet recording apparatus including a piezo-type inkjet head in which a portion from the ink supplying system to the head portion was temperature-adjustable was filled with each obtained curable composition and adjusted to a temperature at which the viscosity would be 10 mPa·s. Subsequently, the curable composition was discharged continuously for 60 minutes at a discharging speed of 3 kHz, to evaluate discharging stability according to the evaluation criteria described below.

Using a temperature-adjustable cone plate rotary viscometer, a temperature condition at which the ink viscosity would be 10.0±0.5 mPa·s was explored, and used as the heating condition for printing.

### —Evaluation Criteria—

A: The curable composition was discharged normally from 95% or more of the nozzles.

B: The curable composition was discharged normally from 90% or more but less than 95% of the nozzles.

C: The curable composition was discharged normally from 70% or higher but less than 90% of the nozzles.

D: The curable composition was discharged normally from less than 70% of the nozzles.

### <Storage Stability>

The initial viscosity of each obtained curable composition was measured immediately ater production, with a cone plate rotary viscometer (instrument name: VISCOMETER TV-22, manufactured by TOKI SANGYO CO., LTD.) with a setting of the temperature of hemathermal circulating water at 25 degrees C. at a number of rotation of 50 rpm at a shear velocity of 191.4 sec⁻¹. Subsequently, each curable composition was left to stand still at 70 degrees C. for 14 days, and the viscosity after storage was measured under the same conditions as the measurement of the initial viscosity. The viscosity change ratio was calculated according to Mathematical formula (7) below. Based on the viscosity change ratio, storage stability was evaluated according to the evaluation criteria described below. A lower viscosity change ratio represents a better storage stability.

Viscosity change ratio (%)=((viscosity after storage at 70 degrees C. for 14 days-initial viscosity)/initial viscosity)×100 Mathematical formula (7)

### —Evaluation Criteria—

A: The viscosity change ratio was 5% or lower.

B: The viscosity change ratio was higher than 5% but 15% or lower.

C: The viscosity change ratio was higher than 15% but 30% or lower.

D: The viscosity change ratio was higher than 30%.

### <Curability>

Using a printer for evaluation obtained by remodeling a printer (apparatus name: SG7100, obtained from Ricoh Company, Ltd.), a solid image of each obtained curable composition was formed with a size of 10 cm×10 cm over a recording medium (product name: COSMOSHINE A4300 COAT PET FILM, obtained from Toyobo Co., Ltd., an average thickness: 100 micrometers, color: clear).

The obtained solid image was cured with a UV-LED device for an inkjet printer (device name: UV-LED MODULE (single-pass water cooling, obtained from Ushio Inc.)), at an illuminance of 1 W/cm² with an amount of light for irradiation of 500 mJ/cm², to obtain an image (cured product) having an average thickness of 10 micrometers and a size of 10 cm×10 cm. The coating film of the solid image was determined to have been cured when the coating film reached a state having no tackiness when touched. With an illuminometer capable of measuring an amount of light of 395 nm, the cumulative amount (J/cm²) of light for irradiation needed for curing was measured. Based on the cumulative amount of light for irradiation needed for curing, curability was evaluated according to the evaluation criteria described below. A curable composition for which the cumulative amount of light for irradiation needed for curing was 2.0 J/cm² or lower was judged as practically usable.

The amount of light for irradiation was measured with an ultraviolet intensity meter (instrument name: UM-10) and a light receiver (instrument name: UM-400)(both obtained from Konica Minolta, Inc.). The method for measuring the average thickness includes measuring thickness at ten positions using an electric micrometer (obtained from Anritsu Corporation) and averaging the measurements. The printer for evaluation was obtained by remodeling the printer SG7100 by incorporating a MH2620 head (obtained from Ricoh Company, Ltd.) in which the head portion was capable of discharging inks through heating via conveying and driving systems of the printer SG7100 and capable of handling high viscosity inks.

### —Evaluation Criteria—

A: 1.0 or lower

B: Higher than 1.0 but 1.5 or lower

C: Higher than 1.5 but 2.0 or lower

D: Higher than 2.0

### (Adhesiveness)

An image (cured product) of each obtained curable composition was obtained with an average thickness of 10 micrometers and a size of 10 cm×10 cm. A solid portion of the obtained image (cured product) was cut into at 1 mm intervals in a grid pattern including 100 grid squares in accordance with JIS K5400, peeled with an adhesive cellophane tape (product name: SCOTCH MENDING TAPE (18 mm), obtained from 3M Company), and observed with a loupe (product name: PEAK No. 1961 (×10), obtained from Tokai Sangyo Co., Ltd.) to count the number of grid squares that were not peeled, to evaluate adhesiveness according to the evaluation criteria described below.

### —Evaluation Criteria—

A: The number of grid squares that were not peeled was 100 grid squares out of 100 grid squares.

B: The number of grid squares that were not peeled was 80 grid squares or more but 99 grid squares or less out of 100 grid squares.

C: The number of grid squares that were not peeled was 40 grid squares or more but 79 grid squares or less out of 100 grid squares.

D: The number of grid squares that were not peeled was 39 grid squares or less out of 100 grid squares.

TABLE 14

| | | Ex. | | | | | | | | | |
|---|---|---|---|---|---|---|---|---|---|---|---|
| | | 2-1 | 2-2 | 2-3 | 2-4 | 2-5 | 2-6 | 2-7 | 2-8 | 2-9 | 2-10 |
| Curable composition No. | | 1 | 2 | 3 | 4 | 5 | 6 | 7 | 8 | 9 | 10 |
| Storage | Viscosity change | 3 | 4 | 3 | 2 | 5 | 2 | 8 | 6 | 7 | 8 |
| stability | ratio (%) | | | | | | | | | | |
| | Evaluation | A | A | A | A | A | A | B | B | B | B |
| Curability | Cumulative amount | 0.7 | 0.4 | 0.3 | 0.4 | 0.5 | 0.2 | 0.7 | 0.4 | 0.5 | 0.8 |
| | of light for irradiation | | | | | | | | | | |
| | needed for curing (J/cm²) | | | | | | | | | | |
| | Evaluation | A | A | A | A | A | A | A | A | A | A |

| | | | | | | | | | | |
|---|---|---|---|---|---|---|---|---|---|---|
| Liquid permeability | A | A | A | A | A | A | A | A | A | A |
| Discharging stability | A | A | A | A | A | B | A | B | A | B |
| Adhesiveness | A | A | A | A | A | A | A | A | A | B |

TABLE 15

| | | Ex. | | | | | | | | | |
|---|---|---|---|---|---|---|---|---|---|---|---|
| | | 2-11 | 2-12 | 2-13 | 2-14 | 2-15 | 2-16 | 2-17 | 2-18 | 2-19 | 2-20 |
| Curable composition No. | | 11 | 12 | 13 | 14 | 15 | 16 | 17 | 18 | 19 | 20 |
| Storage | Viscosity change | 3 | 4 | 3 | 2 | 5 | 2 | 8 | 6 | 7 | 8 |
| stability | ratio (%) | | | | | | | | | | |
| | Evaluation | A | A | A | A | A | A | B | B | B | B |
| Curability | Cumulative amount | 1.2 | 1.1 | 0.5 | 0.6 | 0.9 | 0.9 | 1.0 | 1.4 | 1.2 | 1.1 |
| | of light for irradiation | | | | | | | | | | |
| | needed for curing (J/cm²) | | | | | | | | | | |
| | Evaluation | B | B | A | A | A | A | A | B | B | B |

| | | | | | | | | | | |
|---|---|---|---|---|---|---|---|---|---|---|
| Liquid permeability | A | A | A | A | A | A | A | A | A | A |
| Discharging stability | A | A | B | B | A | B | A | A | A | B |
| Adhesiveness | A | A | A | A | A | A | A | B | A | A |

TABLE 16

| | | Ex. | | | | | | | | | |
|---|---|---|---|---|---|---|---|---|---|---|---|
| | | 2-21 | 2-22 | 2-23 | 2-24 | 2-25 | 2-26 | 2-27 | 2-28 | 2-29 | 2-30 |
| Curable composition No. | | 21 | 22 | 23 | 24 | 25 | 26 | 27 | 28 | 29 | 30 |
| Storage | Viscosity change | 3 | 4 | 3 | 2 | 5 | 2 | 8 | 6 | 7 | 8 |
| stability | ratio (%) | | | | | | | | | | |
| | Evaluation | A | A | A | A | A | A | B | B | B | B |
| Curability | Cumulative amount | 0.4 | 0.3 | 0.4 | 0.5 | 0.4 | 0.3 | 0.5 | 0.8 | 0.4 | 0.5 |
| | of light for irradiation | | | | | | | | | | |
| | needed for curing (J/cm²) | | | | | | | | | | |
| | Evaluation | A | A | A | A | A | A | A | A | A | A |

| | | | | | | | | | | |
|---|---|---|---|---|---|---|---|---|---|---|
| Liquid permeability | B | A | B | A | B | A | A | A | B | B |
| Discharging stability | A | B | A | A | A | B | B | B | A | B |
| Adhesiveness | A | A | A | B | A | A | A | B | A | A |

TABLE 17

| | | Ex. | | | | | | | | | |
|---|---|---|---|---|---|---|---|---|---|---|---|
| | | 2-31 | 2-32 | 2-33 | 2-34 | 2-35 | 2-36 | 2-37 | 2-38 | 2-39 | 2-40 |
| Curable composition No. | | 31 | 32 | 33 | 34 | 35 | 36 | 37 | 38 | 39 | 40 |
| Storage | Viscosity change | 3 | 4 | 3 | 2 | 5 | 2 | 8 | 6 | 7 | 8 |
| stability | ratio (%) | | | | | | | | | | |
| | Evaluation | A | A | A | A | A | A | B | B | B | B |
| Curability | Cumulative amount | 1.0 | 0.8 | 0.9 | 1.1 | 1.2 | 1.1 | 1.0 | 1.5 | 1.7 | 1.3 |
| | of light for irradiation | | | | | | | | | | |
| | needed for curing (J/cm²) | | | | | | | | | | |
| | Evaluation | A | A | A | B | B | B | A | B | C | B |

| | | | | | | | | | | |
|---|---|---|---|---|---|---|---|---|---|---|
| Liquid permeability | A | A | B | A | A | A | A | A | A | A |
| Discharging stability | A | A | A | A | A | B | A | B | A | B |
| Adhesiveness | B | B | B | B | B | B | B | B | B | B |

TABLE 18

| | | Comp. Ex. | | | | | | | |
|---|---|---|---|---|---|---|---|---|---|
| | | 2-1 | 2-2 | 2-3 | 2-4 | 2-5 | 2-6 | 2-7 | 2-8 |
| Curable composition No. | | 41 | 42 | 43 | 44 | 45 | 46 | 47 | 48 |
| Storage | Viscosity change | 130 | 124 | 35 | 89 | 190 | 56 | 398 | 359 |
| stability | ratio (%) | | | | | | | | |
| | Evaluation | D | D | D | D | D | D | D | D |
| Curability | Cumulative amount | 1.1 | 1.2 | 1.4 | 1.5 | 1.5 | 1.2 | 1.4 | 1.8 |
| | of light for irradiation | | | | | | | | |
| | needed for curing (J/cm²) | | | | | | | | |
| | Evaluation | B | B | B | B | B | B | B | C |

| | | | | | | | | |
|---|---|---|---|---|---|---|---|---|
| Liquid permeability | D | D | D | C | D | C | C | D |
| Discharging stability | C | C | D | C | D | C | C | C |
| Adhesiveness | C | C | D | D | C | C | D | D |

TABLE 19

| | | Comp. Ex. | | | | | | | | |
|---|---|---|---|---|---|---|---|---|---|---|
| | | 2-9 | 2-10 | 2-11 | 2-12 | 2-13 | 2-14 | 2-15 | 2-16 | 2-17 |
| Curable composition No. | | 49 | 50 | 51 | 52 | 53 | 54 | 55 | 56 | 57 |
| Storage | Viscosity change | 768 | 490 | 22 | 38 | 355 | 3800 | 455 | 992 | 7600 |
| stability | ratio (%) | | | | | | | | | |
| | Evaluation | D | D | C | D | D | D | D | D | D |
| Curability | Cumulative amount | 1.5 | 1.5 | 2.8 | 3.9 | 4.1 | 4.8 | 5.1 | 5.5 | 5.4 |
| | of light for irradiation | | | | | | | | | |
| | needed for curing (J/cm²) | | | | | | | | | |
| | Evaluation | B | B | D | D | D | D | D | D | D |

| | | | | | | | | | |
|---|---|---|---|---|---|---|---|---|---|
| Liquid permeability | D | D | D | D | D | D | D | D | D |
| Discharging stability | C | D | D | D | D | D | D | D | D |
| Adhesiveness | D | D | D | D | D | D | D | D | D |

From the results of Tables 14 to 19, the curable compositions of Examples 2-1 to 2-1 40 are superior to the curable compositions of Comparative Examples 2-1 to 2-17 in liquid permeability, discharging stability, storage stability, curability, and adhesiveness.

Aspects of the present disclosure are, for example, as follows.

<1> A pigment dispersion composition including:

a yellow pigment;

a polymerizable compound having a solubility parameter (SP value) of 10.00 or greater; and

a pigment dispersant having an amine value of 30 mgKOH/g or greater but 100 mgKOH/g or less,

wherein a ratio (B/A) of a content (B) of the pigment dispersant to a content (A) of the yellow pigment is 0.10 or greater but 0.80 or less.

<2> The pigment dispersion composition according to <1>,

wherein the pigment dispersant is a dispersant polymer, and

wherein the dispersant polymer is one selected from the group consisting of basic functional group-containing copolymers, acrylic block copolymers, and copolymers containing an alkylol ammonium salt and an acid group.

<3> The pigment dispersion composition according to <1> or <2>,

wherein the polymerizable compound is at least one selected from the group consisting of (meth)acryloylmorpholine, hydroxybutyl (meth)acrylate, methoxytetraethylene glycol (meth)acrylate, dicyclopentenyloxyethyl (meth)acrylate, and compounds represented by Structural formula (1) below,

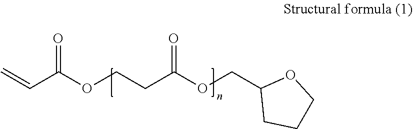

where n represents an integer of 1 or greater.

<4> The pigment dispersion composition according to <3>, wherein the polymerizable compound is (meth)acryloylmorpholine.
<5> The pigment dispersion composition according to any one of <1> to <4>, wherein the yellow pigment is C.I. pigment yellow 138.
<6> The pigment dispersion composition according to any one of <1> to <5>,

wherein the amine value of the pigment dispersant is 30 mgKOH/g or greater but 85 mgKOH/g or less.

<7> A curable composition including

the pigment dispersion composition according to any one of <1> to <6>.

<8> The curable composition according to <7>,

wherein the curable composition is intended for inkjet.

<9> A stored container including:

the curable composition according to <7> or <8>; and

a container,

wherein the curable composition is stored in the container.

<10> A two-dimensional or three-dimensional image forming apparatus including:

a storing part that stores the curable composition according to <7> or <8>;

an applying unit configured to apply the curable composition; and

a curing unit configured to cure the curable composition.

<11> The two-dimensional or three-dimensional image forming apparatus according to <10>,

wherein the curing unit is a UV-LED configured to emit ultraviolet rays having a peak in a wavelength range of 365 nm or longer but 405 nm or shorter.

<12> A two-dimensional or three-dimensional image forming method including: applying the curable composition according to <7> or <8>; and

curing the curable composition.

<13> A cured product including

the curable composition according to <7> or <8>.

<14> A decorated product including

a base material; and

a surface decoration applied over the base material

wherein the surface decoration is formed of the cured product according to <13>.

The pigment dispersion composition according to any one of <1> to <6>, the curable composition according to <7> or <8>, the stored container according to <9>, the two-dimensional or three-dimensional image forming apparatus according to <10> or <11>, the two-dimensional or three-dimensional image forming method according to <12>, the cured product according to <13>, and the decorated product according to <14> can solve the various problems in the related art and achieve the object of the present disclosure.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A pigment dispersion composition comprising:
a yellow pigment;
a polymerizable compound having a solubility parameter of 10.00 or greater; and
a pigment dispersant having an amine value of 30 mgKOH/g or greater but 100 mgKOH/g or less,
wherein a ratio (B/A) of a content (B) of the pigment dispersant to a content (A) of the yellow pigment is 0.10 or greater but 0.80 or less.

2. The pigment dispersion composition according to claim 1,
wherein the pigment dispersant is a dispersant polymer, and
wherein the dispersant polymer is one selected from the group consisting of basic functional group-containing copolymers, acrylic block copolymers, and copolymers containing an alkylol ammonium salt and an acid group.

3. The pigment dispersion composition according to claim 1,
wherein the polymerizable compound is at least one selected from the group consisting of (meth)acryloylmorpholine, hydroxybutyl acrylate, methoxytetraethylene glycol (meth)acrylate, dicyclopentenyloxyethyl (meth)acrylate, and compounds represented by Structural formula (1) below, 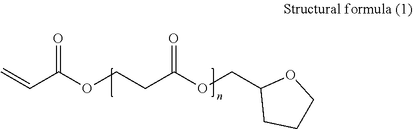
where n represents an integer of 1 or greater.

4. The pigment dispersion composition according to claim 1,
wherein the yellow pigment is C.I. pigment yellow 138.

5. A curable composition comprising
the pigment dispersion composition according to claim 1.

6. The curable composition according to claim 5,
wherein the curable composition is intended for inkjet.

7. A stored container comprising:
the curable composition according to claim 5; and
a container,
wherein the curable composition is stored in the container.

8. A two-dimensional or three-dimensional image forming apparatus comprising:
a storing part that stores the curable composition according to claim 5;
an applying unit configured to apply the curable composition; and
a curing unit configured to cure the curable composition.

9. The two-dimensional or three-dimensional image forming apparatus according to claim 8,
wherein the curing unit is a UV-LED configured to emit ultraviolet rays having a peak in a wavelength range of 365 nm or longer but 405 nm or shorter.

10. A two-dimensional or three-dimensional image forming method comprising:
applying the curable composition according to claim 5; and
curing the curable composition.

11. A cured product comprising
the curable composition according to claim 5.

12. A decorated product comprising:
a base material; and
a surface decoration applied over the base material
wherein the surface decoration is formed of the cured product according to claim 11.
